(19) United States
(12) Patent Application Publication
(10) Pub. No.: US 2024/0417590 A1
(43) Pub. Date: Dec. 19, 2024

(54) PROCESS FOR IMPROVING RESIN PERFORMANCE USING LEWIS ACIDS

(71) Applicant: Borchers GmbH, Langenfeld (DE)

(72) Inventors: Neil John Simpson, Bearsden (GB); Steffen Brand; Martin Klussmann, Langenfeld (DE); Claudia Menzel, Hilden (DE); Sabrina Nehache, Düsseldorf (DE)

(73) Assignee: Borchers GmbH, Langenfeld (DE)

(21) Appl. No.: 18/695,692

(22) PCT Filed: Sep. 26, 2022
(86) PCT No.: PCT/EP2022/076658

§ 371 Date: Mar. 26, 2024

(30) Foreign Application Priority Data
Sep. 30, 2021 (EP) 21200154.9

(51) Int. Cl. C09D 167/06

(52) U.S. Cl. CPC C09D 167/06

(57) ABSTRACT

The invention pertains generally to a process and resulting product of following the steps of the process involving adding an Iron- or Manganese- or Vanadium- or Copper-drier in combination with a multidentate ligand to form a metal—ligand complex with at least two Lewis Acids comprising at least two different Lewis Acid halides to an alkyd resin, said steps performed in any order or the combination performed in-situ.

### CROSS-REFERENCE TO RELATED APPLICATIONS

This application is a national stage application, filed under 35 U.S.C. § 371, of International Patent Application No. PCT/EP2022/076658 filed on Sep. 26, 2022, which claims the benefit of and priority to European patent application number EP21200154.9 filed on Sep. 30, 2021, the disclosures of each of which are hereby incorporated by reference in their entirety.

### TECHNICAL FIELD

The invention described herein pertains generally to an improvement over the use of primary paint driers, typically metal carboxylates like cobalt neodecanoate, which are used to catalyse the oxidative drying (curing) of alkyd resins. Generally, these driers are complexes based on transition metals. Cobalt driers are the most used drying catalysts as they result in highly cross-linked and hard films. Highly cross-linked and hard films are desirable because they have higher scratch, chemical and corrosion resistance. However, several environmental studies have suggested potential reclassification of cobalt-based alkyd driers. See D. Lison, M. De Boeck, V. Veroughstraete and M. Kirsch-Volders “Update on the genotoxicity and carcinogenicity of cobalt compounds” Occupational and Environmental Medicine, 2001, 58, 619-25 and see J. R. Bucher, J. R. Hailey, J. R. Roycroft, J. K. Haseman, R. C. Sills, S. L. Brumbein, P. W. Mellick and B. J. Chou, “Inhalation toxicity and carcinogenicity studies of cobalt sulfate,” Toxicological Sciences, 1999, 49, 56-67.

Borchi® Oxy Coat, (synonymous with “BOC” in this application) is a primary drier for alkyds. There are at least three patent families linked to Borchi® Oxy-Coat (i.e. EP2038356, EP2521750, EP2474578) that cover the use of the catalyst in different delivery forms, and variations of the structure, in formulation, for oxidatively cured coatings, inks and composites. It has been shown that Borchi® Oxy-Coat shows faster curing and less yellowing of alkyd films at much lower concentrations than cobalt, and is a non-toxic alternative to cobalt-based driers.

Literature (see Ozlem Gezici-Koç, Charlotte A. A. M. Thomas, Marc-Edouard B. Michel, Sebastiaan J. F. Erich, Hendrik P. Huinink, Jitte Flapper, Francis L. Duivenvoorde, Leendert G. J. van der Ven, Olaf C. G. Adan, “In-depth study of drying solvent-borne alkyd coatings in presence of Mn- and Fe-based catalysts as cobalt alternatives”, Mater. Today Commun., 2016 7, 22-31), in combination with internal observations have resulted in the hypothesis that BOC compared to Co is: poor at the initiation steps of the curing mechanism; poor in the transport of oxygen; and excellent at peroxide decomposition. The system lacks deep cross-linking and the formation of a hard film.

Therefore, there is a need for non-cobalt based driers as alternatives. The lack of hardness impacts the use of BOC as a cobalt replacement in more demanding applications, such as direct to metal coatings or decorative coatings, to allow scratch resistance, improved corrosion resistance and the ability to stack painted pieces quickly.

### BACKGROUND OF THE INVENTION

The invention relates to an improved approach to imparting hardness to oxidatively curable water-based coating compositions, such as alkyd coatings, using at least two different Lewis Acids or a mixture of Lewis Acids, preferably Lewis Acid halides.

In this invention, new ways were explored to boost the performance of BOC. One approach was to chemically activate the double bonds to make them more reactive. Lewis acidic metal soaps (so-called secondary driers) have been used for decades and some studies have tried to explain how they work. See L. Dubrulle, R. Lebeuf, L. Thomas, M. Fressancourt-Collinet and V. Nardello-Rataj, Progress in Organic Coatings, 2017, 104, 141-151; and S. J. F. Erich, O. Gezici-Koc, M.-E. B. Michel, C. A. A. M. Thomas, L. G. J. van der Ven, H. P. Huinink, J. Flapper, F. L. Duivenvoorde and O. C. G. Adan, Polymer, 2017, 121, 262-273. These compounds often are metal soaps of carboxylic acids. The first modern driers were developed in the early 1920's with the preparation of metal naphthenates. The driers that are used today are based upon synthetic acids, like 2-ethyl hexanoic acid and versatic acid. The advantage of using carboxylic acids is the high solubility in the apolar environment of the oil-paint binder system which prevents precipitation of the complex.

However, this technology seems to be fairly mature and challenging to improve. At least one possible explanation could be that these carboxylates are strongly coordinating groups that lead to a charge compensation of the respective metal centres, which results in a lower Lewis acidity of the latter. In addition, the carboxylate may act as a bidentate bridging ligand, resulting in cluster formation. This would reduce the total active dryer concentration in the film.

### SUMMARY OF THE INVENTION

The present invention is directed to an improved approach to imparting hardness to oxidatively cured coatings, such as alkyd coatings, whilst maintaining good, or even improved drying times, to especially address an issue with catalysts prepared using polydentate amine ligands such as BOC. The invention allows for the use of non-carcinogenic catalysts as a replacement for toxic, hypothetically carcinogenic cobalt catalysts in alkyd costings, by enabling superior performance to the afore-mentioned catalysts.

It has been found that combinations of at least two Lewis acids, particularly based on metal halide salts, and only when combined, dramatically improved the hardness development of films when using Borchi Oxy Coat.

In this invention, it has been found that simple halogenated salts of aluminum and potassium gave little advantage, but the combination of both gave a boosted performance. Furthermore, this only worked for Borchi Oxy Coat, and not for Cobalt-based driers as illustrated in Table 1.

The components of this invention are either added in a pre-formed state (e.g., BOC plus ligands) or formed in-situ. The Lewis acids (at least two or more) can be added to the resin either before or after the addition of the primary drier, or as a pre-blended combination. Optionally, various other additives are added as illustrated below.

Phrased similarly, the invention may be practiced by contacting a ligand with a metal source to create the metal-ligand combination that will then be combined with the at least two Lewis acids, or to use the premade catalyst, like BOC, to combine with the at least two Lewis acids. All of these variations are within the scope of this invention

At least one object of the invention is achieved by formulating an oxidatively cured coating using:
(A) At least one oxidatively cured water-based resin, for example an alkyd resin;
(B) At least one primary drier, such as BOC, Borchi Dragon, or other driers with multidentate amine-based ligands combined or complexed to metal salts of iron, vanadium, manganese or copper;
(C) At least two Lewis acids and preferably mixtures and blends of at least two or more Lewis Acids having one or more of the following characteristics:
   a) The Lewis Acids being preferably Lewis Acid halides or acetates;
   b) The Lewis Acid halides or acetates preferably based on Al and K salts used in combination;
   c) Synergies may also include other combinations of Lewis Acid metals, such as those in the following IUPAC groups of the Periodic Table (with the old IUPAC name in parenthesis):
      i) Group 1 (Group IA alkali metals in the Li family, namely Li, Na, K, Rb, & Cs);
      ii) Group 2 (Group IIA, alkaline earth metals in the Be family, namely Be, Mg, Ca, Sr & Ba);
      iii) Group 3 (Group IIIA, transition metals in the Sc family, namely Sc & Y);
      iv) Group 4 (Group IVA, transition metals in the Ti family, namely Ti, Zr & Hf);
      v) Group 12 (Group IIB, volatile metals in the Zn family, namely Zn & Cd);
      vi) Group 13 (Group IIIB, icoasagens of the B family, namely B, Al, Ga & In) and
      vii) Groups 4-12 of Row 4 (i.e., Sc, Ti, V, Cr, Mn, Fe, Co, Ni, Cu and Zn); and
      viii) the Lanthanide series (i.e., La, Ce, Pr, Nd, Pm, Sm, Eu, Gd, Tb, Dy, Ho, Er, Tm, Yb and Lu); and
      ix) Bi (bismuth).
(D) Optionally, at least one antiskinning agent;
(E) Optionally at least one pigment or dye;
(F) Optionally other additives, such as at least one pigment dispersant or at least one rheology additive; adding at least one antiskinning compound; adding one or more auxiliary driers or secondary driers; adding at least one UV stabilizer; adding at least one dispersant; adding at least one surfactant; adding at least one corrosion-inhibitor; adding at least one filler; adding at least one antistatic agent; adding at least one flame-retardant; adding at least one lubricant; adding at least one antifoaming agent; adding at least one antifouling agent; adding at least one bactericides; adding at least one fungicide; adding at least one algaecide; adding at least one insecticide; adding at least one extender; adding at least one plasticizer; adding at least one antifreezing agent; adding at least one wax; adding at least one thickener; and
(G) At least one aqueous solvent; and
(H) Optionally the addition of a copper salt.

These and other objects of this invention will be evident when viewed in light of detailed description and appended claims.

### DETAILED DESCRIPTION OF THE INVENTION

Whilst progress has been made to replace the use of toxic cobalt in alkyd coatings, cobalt carboxylates are still unparalleled in their ability to provide hard coatings upon curing. BOC, and other catalysts based on transition metal complexes or salts of polydentate nitrogen-donating ligands outperform cobalt for drying times, but create softer coatings, which prevents the total replacement of cobalt in all coating applications.

The present invention is based upon the surprising finding that the introduction of a combination of metal halide or acetate salts, in combination with a primary drier comprising a complex of a transition metal ion and a polydentate accelerant ligand into an oxidatively curable solvent-based coating composition serves not only to increase the hardness of the coating significantly, but also the dry time. More surprisingly, this effect is not seen for cobalt carboxylates.

The invention has broad utility in relation to a wide variety of water-based coating compositions, which term is to be interpreted broadly herein. Examples of coating compositions include clear or coloured varnishes, primary coats, filling pastes, glazes, primers, direct to metal coatings, emulsions and floor coatings, e.g., linoleum floor coverings. Embodiments of the invention relate to water-based paints and inks, particularly paints such as high-specification paints intended for industrial use.

The use of the term “oxidatively curable water-based coating compositions” as used herein is thus intended to embrace a wide variety of coloured (e.g., by way of pigment or ink) and non-coloured materials, including oils and binders, which form a continuous coating through the course of oxidative reactions, typically to form cross-linkages and other bond formations. Generically, such coating compositions may be characterized by the presence of typically (poly) unsaturated resins that react to form a solid film on a substrate, the resins being initially present in the oxidatively curable water-based coating compositions either as liquids, dissolved in a solvent or as solids dispersed in a continuous liquid phase. Reaction to form the desired coating upon curing arises from polymerisation reactions initiated by oxidation. Examples of oxidatively curable coating compositions include alkyd-, acrylate-, urethane-, polybutadiene- and epoxy ester-based resins. Typically, the curable (e.g., alkyd resin) portion of the curable composition will comprise between about 1% by weight and about 90% by weight of the total weight of the oxidatively curable water-based coating composition, e.g. between about 20 and about 70% by weight of the total weight of the oxidatively curable water-based coating composition.

Alkyd resins are a particularly important member of the class of oxidatively curable coating compositions and are a well-studied class of resin to which the present invention may be applied. Hereinafter, embodiments of the invention are described with reference to the use of alkyd resins, also referred to as alkyd-based resins or alkyd(-based) binders. Whilst these represent particularly significant embodiments of the invention, the invention is not to be so limited. Alkyd resins are nonlinear polymers prepared by an esterification reaction of a polybasic organic acid with a polyhydric alcohol and, in this invention, also with drying oils or drying oil fatty acids. They can be modified with dibasic, tribasic or tetrabasic organic acids or anhydrides or monobasic organic acids. Typical polyhydric alcohols that can be used to prepare alkyd resins are as follows: ethylene glycol, propylene glycol, 1,3-butylene glycol, pentanediol, neopentyl glycol, hexylene glycol, diethylene glycol, dipropylene glycol, triethylene glycol, glycerine (99%), glycerine (95%), trimethylolethane, trimethylolpropane, pentaerythritol, methylglucoside, dipentaerythritol, and sorbitol.

Typical dibasic organic acids and anhydrides that can be used to prepare alkyd resins are as follows: adipic acid, azelaic acid, chlorendic acid, chlorendic anhydride, fumaric acid, isophthalic acid, phthalic anhydride, terephthalic acid, maleic anhydride, succinic acid, succinic anhydride, sebacic acid, and diglycolic acid.

Typical tribasic and tetrabasic organic acids that can be used to prepare alkyd resins are as follows: citric acid, maleated fatty acids, trimellitic acid, trimellitic anhydride, pyromellitic acid and pyromellitic dianhydride.

Typical drying oils that can be used to prepare alkyd resins are as follows: castor oil, heat-bodied soya oil, coconut oil, corn oil, cottonseed oil, dehydrated castor oil, linseed oil, oiticica oil, safflower oil, soybean oil, and tung oil. Also usable are fatty acids derived from the above oils, tall oil, short chain aliphatic acids such as hexanoic acid, and aromatic acids such as benzoic acid. Alkyd resins can also be modified with other chemistries, such as, but not limited to, polyacrylic or polyurethane functionality.

To be clear: the invention is applicable to a wide range of oxidatively curable coating compositions, typically those comprising at least 1 or 2% by weight of an unsaturated compound (e.g., comprising unsaturated (non-aromatic) double or triple carbon-carbon bonds).

As used in this application, where percentages by weight are referred to herein (wt. % or wt % or % w/w), this means, unless a context clearly dictates to the contrary, percentages by weight with respect to the solid resin resultant from curing, i.e. components of the oxidatively curable water-based coating compositions that serve to provide the coating upon curing. With an oxidatively curable alkyd coating composition, therefore, the combined weights of the components of the composition that become, i.e., are incorporated into, the alkyd resin coating, i.e., once cured, are those with respect to which weight percentages herein are based. For example, the composition, either resultant from conducting the method according to the first aspect of the invention, or according to the second aspect of the invention, typically comprises about 0.0001% to about 1% Lewis acid based on metal on resin solids (synonymously “MOR”), more narrowly 0.05 to 0.5% metal on resin solids MOR.

By oxidatively curable water-based compositions is meant herein, consistent with the nomenclature used in the art, compositions that are based on water as the solvent, the alkyd resin could be water soluble, water reducible or water dispersed. The resin may be fully dissolved into the solvent, or supplied in the form of a latex—any water-dissipatible, water-dispersible, or water-reducible (i.e. able to get into water). Water-reducible alkyds are typically modified to add water-miscibility, they are waterborne or water-based coatings that include latex alkyds, where water constitutes the majority of the solvent used to disperse the resin used to make the coating or paint. Water-reducible coatings are widely used due to their low volatile organic compounds (VOC) content. Organic co-solvents may be present, including. aliphatic (including alicyclic and branched) hydrocarbons, such as hexane, heptane, octane, cyclohexane, cycloheptane and isoparaffins; aromatic hydrocarbons such as toluene and xylene; ketones, e.g. methyl ethyl ketone and methyl isobutyl ketone; alcohols, such as isopropyl alcohol, n-butyl alcohol and n-propyl alcohol; glycol monoethers, such as the monoethers of ethylene glycol and diethylene glycol; monoether glycol acetates, such as 2-ethoxyethyl acetate; as well as mixtures thereof. Isomeric variants are included. Thus, the term hexane embraces mixtures of hexanes. According to particular embodiments of the invention, the solvent or co-solvent is a hydrocarbyl (i.e., hydrocarbon) solvent, e.g., an aliphatic hydrocarbyl solvent, e.g., solvents comprising mixtures of hydrocarbons. Examples include white spirit and solvents available under the trademarks Shellsol™, from Shell Chemicals and Solvesso™ and Exxsol®, from Exxon.

The compositions encompassed by the invention comprise a transition metal drier, which is a complex of a transition metal ion and an accelerant ligand, preferably a polydentate accelerant ligand. Each of these components will be further described herein.

The transition metal ions used in oxidatively curable coating compositions may be provided by any convenient water-soluble metal salt, for example a vanadium, manganese, iron, cobalt, nickel, copper, cerium or lead salt, more typically vanadium, manganese, iron or cerium salt, or salts comprising mixtures of either of the foregoing lists of metal ions. The valency of the metal may range from +1 to +5. Embodiments of the invention comprise manganese-, iron-, copper- and/or vanadium-containing ions. Mixtures of ions may be provided. Where an iron-containing drier is provided, this is usually as an Fe(II) or Fe(III) compound. Where a manganese drier is provided, this is usually as a Mn (II), (III) or (IV) compound; and where a vanadium-containing drier is provided this is usually as a V(II), (III), (IV) or (V) compound and where the copper-containing drier is provided, this is usually as a Cu(I) or Cu(II) compound.

As is known, the facility of the metal drier to catalyse the desired oxidation chemistry of oxidatively curable coating compositions arises from its ability to participate in redox chemistry; the nature of the counteranion is not believed to be of great importance. This may serve to provide a readily water-soluble salt such as a halide (e.g., chloride), sulfate or acetate. Other counterions are evident to the skilled person.

To enhance the activity of the transition metal ions a so-called accelerating compound, herein the “polydentate accelerant ligand”, is also included. As the language suggests the term polydentate accelerant ligand is a compound capable of coordinating to the transition metal ion by way of more than one donor site within the ligand and serves to accelerate the drying (curing process) of the oxidatively curable coating composition after application.

According to some embodiments of the invention the polydentate accelerant ligand is a bi-, tri-, tetra-, penta- or hexadentate ligand coordinating through nitrogen and/or oxygen donor atoms. In particular embodiments of the invention, the ligand is a bi-, tri-, tetra-, penta- or hexadentate nitrogen donor ligand, in particular a tri-, tetra-, penta-, or hexadentate nitrogen donor ligand. However, the invention is not so limited.

As used herein the term “nitrogen-donor ligand” or “ligand” or “L” is an organic structure or molecule which will support coordinating nitrogen atoms. In the present invention, said at least one nitrogen-donor ligand is selected from the group comprising tridentate, tetradentate, pentadentate and hexadentate nitrogen donor ligands.

Whenever the term “substituted” is used herein, it is meant to indicate that one or more hydrogens on the atom indicated in the expression using “substituted” is replaced with a selection from the indicated group, provided that the indicated atom's normal valency is not exceeded, and that the substitution results in a chemically stable compound, i.e., a compound that is sufficiently robust to survive isolation from a reaction mixture.

The best mode for carrying out the invention will now be described for the purposes of illustrating the best mode known to the applicant at the time of the filing of this invention. The examples and figures are illustrative only and not meant to limit the invention, as measured by the scope of the claims.

Unless the context clearly indicates otherwise: the word “and” indicates the conjunctive; the word “or” indicates the disjunctive; when the article is phrased in the disjunctive, followed by the words “or both” or “combinations thereof” both the conjunctive and disjunctive are intended.

As used in this application, the term “approximately” is within 10% of the stated value, except where noted.

Throughout the description and claims generic groups are often used, for example alkyl, alkoxy, aryl. Unless otherwise specified, the following are preferred group restrictions that may be applied to generic groups found within compounds disclosed herein.

As used herein, “alkyl” will mean linear and branched C₁₋₈-alkyl saturated acyclic hydrocarbon monovalent groups; said alkyl group may further optionally include one or more suitable substituents independently selected from the group consisting of amino, halogen, hydroxy, sulfhydryl, haloalkyl, alkoxy and the like.

As used herein, “alkenyl” will mean straight and branched C₂₋₆ unsaturated acyclic hydrocarbon monovalent groups; said alkenyl group may further optionally include one or more suitable substituents independently selected from the group consisting of amino, halogen, hydroxy, sulfhydryl, haloalkyl, alkoxy and the like.

As used herein, “cycloalkyl” shall mean C₃₋₈ monosaturated hydrocarbon monovalent group, or a C₇₋₁₀ polycyclic saturated hydrocarbon monovalent group.

As used herein, “aryl” shall mean selected from homoaromatic compounds having a molecular weight preferably under 300.

As used herein “heteroaryl” shall mean selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl.

As used herein “heterocycloalkyl” shall mean selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl.

As used herein “carboxylate derivative” shall mean the group —C(O)OR, wherein R is selected from: hydrogen; C₁-C₆-alkyl; phenyl; C₁-C₆-alkyl-C₆H₅; Li; Na; K; Cs; Mg; and Ca, carbonyl derivative: the group —C(O)R, wherein R is selected from: hydrogen; C₁-C₆-alkyl; phenyl; C₁-C₆-alkyl-C₆H₅ and amine (to give the amide) selected from the group: —NR′₂, wherein each R′ is independently selected from: hydrogen; C₁-C₆-alkyl; C₁-C₆-alkyl-C₆H₅; and phenyl, wherein when both R′ are C₁-C₆-alkyl both R′ together may form an —NC3 to an —NC5 heterocyclic ring with any remaining alkyl chain forming an alkyl substituent to the heterocyclic ring, sulphonate: the group —S(O)₂OR, wherein R is selected from: hydrogen; C₁-C₆-alkyl; phenyl; C₁-C₆-alkyl-C₆H₅; Li; Na; K; Cs; Mg; and Ca.

Unless otherwise specified, the following are more preferred group restrictions that may be applied to groups found within compounds disclosed herein:
(a) alkyl: linear and branched C₁₋₈-alkyl;
(b) alkenyl: C₃₋₈-alkenyl;
(c) cycloalkyl: C₆₋₈-cycloalkyl;
(d) aryl: selected from group consisting of: phenyl; biphenyl; naphthalenyl; anthracenyl; and phenanthrenyl;
(e) heteroaryl: selected from the group consisting of: pyridinyl; pyrimidinyl; quinolinyl; pyrazolyl; triazolyl; isoquinolinyl; imidazolyl; and oxazolidinyl, wherein the heteroaryl may be connected to the compound via any atom in the ring of the selected heteroaryl; and
(f) heterocycloalkyl: selected from the group consisting of: pyrrolidinyl; morpholinyl; piperidinyl; piperidinyl; 1,4-piperazinyl; tetrahydrofuranyl; 1,4,7-triazacyclononanyl; 1,4,8,11-tetraazacyclotetradecanyl; 1,4,7,10,13-pentaazacyclopentadecanyl; 1,4,7,10-tetraazacyclododecanyl; and piperazinyl, wherein the heterocycloalkyl may be connected to the compound via any atom in the ring of the selected heterocycloalkyl, carboxylate derivative: the group —C(O)OR, wherein R is selected from hydrogen; Na; K; Mg; Ca; C₁-C₆-alkyl; and benzyl.

As used herein, and unless otherwise stated, the term “arylalkyl” refers to an aliphatic saturated hydrocarbon monovalent group onto which an aryl group (such as defined above) is attached, and wherein the said aliphatic or aryl groups may be optionally substituted with one or more substituents independently selected from the group consisting of halogen, amino, hydroxyl, sulfhydryl, alkyl, haloalkyl and nitro. Specific examples of the arylalkyl groups are those having 7 to 40 carbon atoms wherein the alkyl group may be straight-chain or branched, such as benzyl, phenylethyl, phenylpropyl, phenylbutyl, phenylpentyl and phenylhexyl groups.

As used herein, and unless otherwise stated, the term “alkylaryl” refers to an aryl group (such as defined above) onto which an aliphatic saturated hydrocarbon monovalent group is attached, and wherein the said aliphatic or aryl groups may be optionally substituted with one or more substituents independently selected from the group consisting of halogen, amino, hydroxyl, sulfhydryl, alkyl, trifluoromethyl and nitro. Specific non-limiting examples of the unsubstituted or alkyl-substituted aryl groups are the aryl groups having 6 to 18 carbon atoms such as phenyl, diphenyl and naphthyl groups, and alkylaryl groups having 7 to 40 carbon atoms wherein the alkyl group may be straight-chain or branched and may be bonded to any position on the aryl group, such as tolyl, xylyl, ethylphenyl, propylphenyl, butylphenyl, pentylphenyl, hexylphenyl, heptylphenyl, octylphenyl, nonylphenyl, decylphenyl, undecylphenyl, dodecylphenyl, diethylphenyl, dibutylphenyl and dioctylphenyl groups. The alkylaryl groups may additionally have substituents including functional groups such as alkoxy, hydroxy, cyano, nitro, halides, carboxylic acids, etc.

As used herein, “Deca-Co-7”, means Borchers® Deca Cobalt 7 aqua, a clear, middle-viscous violet liquid having a Co metal content between 6.8-7.2% ISO 4619, and having a viscosity between 200-980 mPa·s (20° C.) ISO 3219 (A) and a density of 0.98 g/cm³ DIN 51757 (20° C.).

As used herein, “Beckosol AQ® 206” is a medium oil alkyd latex based on bio-renewable fatty acids that combines excellent initial film color and color stability with good cure speed. Beckosol AQ 206 requires no coalescing solvent for film formation and produces AIM compliant coatings that develop the performance of traditional solvent-borne products. Beckosol AQ 206 does not contain alkyl phenol ethoxylates. In appearance it appears milky white with a percent solids by weight of 55% and a percentage of solids by volume of 52.5%. The Brookfield viscosity, at 50 RPM using a #3 spindle is 100 cps and a pH of 7.0. It has a mild odor and a volatile content (Percent) Water, proprietary surfactant of (44.2%, 0.8%).

Often, the metal drier, sometimes referred to as a siccative, is present in the curable liquid composition at a concentration of from about 0.0001 and 0.1% w/w, more typically from 0.001 and 0.1% w/w, more typically from 0.002 and 0.05% w/w, even more typically from 0.005 to 0.05% w/w.

The polydentate accelerant ligand, e.g., a tetradentate, pentadentate or hexadentate nitrogen donor ligand, may be built up within any organic structure which will support coordinating nitrogen atoms. For example, one can take a basic tridentate ligand such as 1,4,7-triazacyclononane (TACN), optionally substituted with further nitrogen coordinating groups, e.g., —CH₂—CH₂—NH₂, —CH₂-Py (Py=pyridyl, typically 2-pyridyl), covalently bound to one or more of the nitrogen atoms within the tridentate ligand (e.g., TACN) or aliphatic groups (e.g. one or more of the ethylene diradicals in TACN).

If present, the iron ions may be selected from Fe(II) and/or Fe(III); manganese ions may be selected from Mn(II), Mn(III), and Mn(IV), or vanadium ions selected from V(II), V(III), (III), (IV) and (V), or mixtures thereof. According to some embodiments, the transition metal drier comprises the polydentate accelerant ligand and is a mono- or bidentate ligand of one of the foregoing ions, or a mixture thereof.

The polydentate accelerant ligand (L) may be provided, for example, in complexes of one or more of the formulae: [MnLCl₂]; [FeLCl₂]; [FeLCl]Cl; [FeL(H₂O)](PF₆)₂; [FeL]Cl₂, [FeLCl]PF₆ and [FeL(H₂O)](BF₄)₂ as well as iron carboxylates, e.g., iron neodecanoate. It will be understood that the counteranions shown in the complexes may equally coordinate to other transition metal ions if desired, e.g. of vanadium or manganese.

Below are described classes of polydentate accelerant ligand transition metal driers that are iron or manganese complexes of tetradentate, pentadentate or hexadentate nitrogen donor ligands.

If unspecified, the length of an alkyl chain is C₁-C₈ alkyl and preferably is linear. If unspecified, the length of an alkenyl or alkynyl chain is C₂-C₈ and preferably is linear. If unspecified an aryl group is a phenyl group.

### BISPIDON

The bispidon class are typically in the form of an iron transition metal catalyst. The bispidon ligand is preferably of the formula:

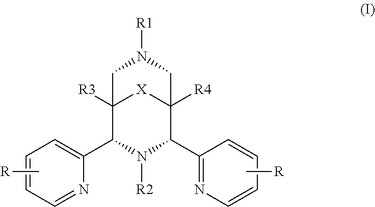

wherein:
each R is independently selected from the group consisting of hydrogen, F, Cl, Br, hydroxyl, C₁₋₄-alkylO-, —NH—CO—H, —NH—CO—C₁₋₄alkyl, —NH₂, —NH—C₁₋₄alkyl, and C₁₋₄alkyl;
R1 and R2 are independently selected from the group consisting of C₁₋₂₄alkyl, C₆₋₁₀aryl, and a group containing one or two heteroatoms (e.g. N, O or S) capable of coordinating to a transition metal;
R3 and R4 are independently selected from the group consisting of hydrogen, C₁₋₈alkyl, C₁₋₈alkyl-O—C₁₋₈alkyl, C₁₋₈alkyl-O—C₆₋₁₀aryl, C₆₋₁₀aryl, C₁₋₈hydroxyalkyl and —(CH₂)ₙC(O)OR5 wherein R5 is independently selected from hydrogen and C₁₋₄alkyl,
n is from 0 to 4
X is selected from the group consisting of C═O, —[C(R6)₂]_{y}— wherein y is from 0 to 3; and
each R6 is independently selected from the group consisting of hydrogen, hydroxyl, C₁₋₄ alkoxy and C₁₋₄ alkyl.

Often R3=R4 and is selected from —C(O) —O—CH₃, —C(O) —O—CH₂CH₃, —C(O)—O—CH₂C₆H₅ and CH₂OH. Often the heteroatom capable of coordinating to a transition metal is provided by pyridin-2-ylmethyl optionally substituted by C₁₋₄alkyl or an aliphatic amine optionally substituted by C₁₋₈alkyl. Often X is C═O or C(OH)₂.

Typical groups for —R1 and —R2 are —CH₃, —C₂H₅, —C₃H₇, -benzyl, —C₄H₉, —C₆H₁₃, —C₈H₁₇, —C₁₂H₂₅, and —C₁₈H₃₇ and -pyridin-2-yl. An example of a class of bispidon is one in which at least one of R1 or R2 is pyridin-2-ylmethyl or benzyl or optionally alkyl-substituted amino-ethyl, e.g., pyridin-2-ylmethyl or N,N-dimethylamino-ethyl.

Two examples of bispidons are dimethyl 2,4-di-(2-pyridyl)-3-methyl-7-(pyridin-2-ylmethyl)-3,7-diaza-bicyclo[3.3.1]nonan-9-one-1,5-dicarboxylate (N2py3o-C1) and dimethyl 2,4-di-(2-pyridyl)-3-methyl-7-(N,N-dimethyl-amino-ethyl)-3,7-diaza-bicyclo[3.3.1]nonan-9-one-1,5-dicarboxylate and the corresponding iron complexes thereof. FeN2py3o-C1 may be prepared as described in WO 02/48301. Other examples of bispidons are those which, instead of having a methyl group at the 3-position, have longer alkyl chains (e.g. C₄-C₁₈alkyl or C₆-C₁₈alkyl chains) such as isobutyl, (n-hexyl) C6, (n-octyl) C8, (n-dodecyl) C12, (n-tetradecyl) C14, (n-octadecyl) C18; these may be prepared in an analogous manner.

N4py type

The N4py type ligands are typically in the form of an iron transition metal catalyst. The N4py type ligands are typically of the formula (II):

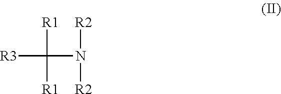

wherein:
each R1 and R2 independently represents —R4-R5;
R3 represents hydrogen, C₁₋₈-alkyl, aryl selected from homoaromatic compounds having a molecular weight under 300, or C₇₋₄₀ arylalkyl, or —R4-R5,
each R4 independently represents a single bond or a linear or branched C₁₋₈-alkyl-substituted-C₂₋₆-alkylene, C₂₋₆-alkenylene, C₂₋₆-oxyalkylene, C₂₋₆-aminoalkylene, C₂₋₆-alkenyl ether, C₂₋₆-carboxylic ester or C₂₋₆-carboxylic amide, and
each R5 independently represents an optionally N-alkyl-substituted aminoalkyl group or an optionally alkyl-substituted heteroaryl: selected from the group consisting of pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl.

Accordingly, to some embodiments R1 or R2 represents pyridin-2-yl; or R2 or R1 represents 2-amino-ethyl, 2-(N-(m)ethyl)amino-ethyl or 2-(N,N-di(m)ethyl)amino-ethyl. If substituted, R5 often represents 3-methyl pyridin-2-yl. R3 preferably represents hydrogen, benzyl or methyl.

Examples of N4Py ligands include N4Py itself (i.e. N, N-bis(pyridin-2-yl-methyl)-bis(pyridin-2-yl)methylamine which is described in WO 95/34628); and MeN4py (i.e. N,N-bis(pyridin-2-yl-methyl-1,1-bis(pyridin-2-yl)-1-aminoethane) and BzN4py (N,N-bis(pyridin-2-yl-methyl-1,1-bis(pyridin-2-yl)-2-phenyl-1-aminoethane) which are described in EP 0909809.

### TACN-Type

The TACN-Nx are preferably in the form of an iron transition metal catalyst. These ligands are based on a 1,4,7-triazacyclononane (TACN) structure but have one or more pendent nitrogen groups that serve to complex with the transition metal to provide a tetradentate, pentadentate or hexadentate ligand. According to some embodiments of the TACN-Nx type of ligand, the TACN scaffold has two pendent nitrogen-containing groups that complex with the transition metal (TACN-N2). TACN-Nx ligands are typically of the formula (III):

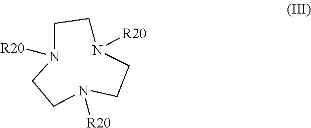

wherein
each R20 is independently selected from: C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, or C₇₋₄₀-arylalkyl group optionally substituted with a substituent selected from hydroxy, alkoxy, phenoxy, carboxylate, carboxamide, carboxylic ester, sulfonate, amine, alkylamine and N′(R21)₃,
R21 is selected from hydrogen, C₁₋₈-alkyl, C₂₋₆-alkenyl, C₇₋₄₀-arylalkyl, arylalkenyl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂-R22,
Y is independently selected from H, CH₃, C₂H₅, C₃H₇ and
R22 is independently selected from C₁₋₈-alkyl-substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl; and
   wherein at least one of R20 is a —CY₂-R22.

R22 is typically selected from optionally alkyl-substituted pyridin-2-yl, imidazol-4-yl, pyrazol-1-yl, quinolin-2-yl groups. R22 is often either a pyridin-2-yl or a quinolin-2-yl.

### CYCLAM and Cross-Bridged Ligands

The cyclam and cross-bridged ligands are preferably in the form of a manganese transition metal catalyst. The cyclam ligand is typically of the formula (IV):

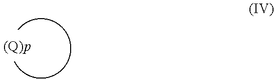

wherein:
Q is independently selected from

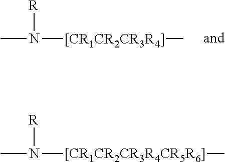

ρ is 4;
R is independently selected from: hydrogen, C₁₋₆-alkyl, CH₂CH₂OH, pyridin-2-ylmethyl, and CH₂OOOH, or one of R is linked to the N of another Q via an ethylene bridge; and
R₁, R₂, R₃, R₄, R₅ and R₆ are independently selected from: H, C₁₋₄-alkyl, and C₁₋₄-alkylhydroxy.

Examples of non-cross-bridged ligands are 1,4,8,11-tetraazacyclotetradecane (cyclam), 1,4,8,11-tetramethyl-1,4,8,11-tetraazacyclotetradecane (Me4cyclam), 1,4,7,10-tetraazacyclododecane (cyclen), 1,4,7,10-tetramethyl-1,4,7,10-tetraazacyclododecane (Me4cyclen), and 1,4,7,10-tetrakis(pyridine-2ylmethyl)-1,4,7,10-tetraazacyclododecane (Py4cyclen). With Py4cyclen the iron complex is preferred.

A preferred cross-bridged ligand is of the formula (V):

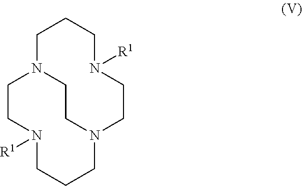

wherein
R¹ is independently selected from H, C₁₋₂₀ alkyl, C₇₋₄₀-alkylaryl, C₂₋₆-alkenyl or C₂₋₆-alkynyl.

All nitrogen atoms in the macropolycyclic rings may be coordinated with a transition metal. In formula (VI), each R¹ may be the same. Where each R¹ is Me, this provides the ligand 5,12-dimethyl-1,5,8,12-tetraaza-bicyclo[6.6.2]hexadecane (L) of which the complex [Mn(L)Cl₂] may be synthesised according to WO98/39098. Where each R1=benzyl, this is the ligand 5,12-dibenzyl-1,5,8,12-tetraaza-bicyclo[6.6.2]hexadecane (L′) of which the complex [Mn(L′)Cl₂] may be synthesised as described in WO 98/39098. Further suitable crossed-bridged ligands are described in WO98/39098.

### TRISPICEN-Type

The trispicens are preferably in the form of an iron transition metal catalyst. The trispicen type ligands are preferably of the formula (VI):

R17R17N—X—NR17R17 (VI),

wherein:
X is selected from —CH₂CH₂—, —CH₂CH₂CH₂—, —CH₂C(OH)HCH₂—;
each R17 independently represents a group selected from: R17, C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, and C₇₋₄₀ arylalkyl groups optionally substituted with a substituent selected from hydroxy, alkoxy, phenoxy, carboxylate, carboxamide, carboxylic ester, sulfonate, amine, alkylamine and N⁺(R19)₃, wherein
R19 is selected from hydrogen, C₁₋₈-alkyl, C₂₋₆-alkenyl, C₇₋₄₀-arylalkyl, C₇₋₄₀-arylalkenyl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂-R18, in which each Y is independently selected from H, CH₃, C₂H₅, C₃H₇ and R18 is independently selected from an optionally substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl; and at least two of R17 are —CY₂-R18.

The heteroatom donor group is preferably pyridinyl, e.g. 2-pyridinyl, optionally substituted by —C₁-C₄-alkyl.

Other preferred heteroatom donor groups are imidazol-2-yl, 1-methyl-imidazol-2-yl, 4-methyl-imidazol-2-yl, imidazol-4-yl, 2-methyl-imidazol-4-yl, 1-methyl-imidazol-4-yl, benzimidazol-2-yl and 1-methyl-benzimidazol-2-yl. Preferably three of R17 are CY₂-R18.

The ligand Tpen (N, N, N′, N′-tetra(pyridin-2-yl-methyl)ethylenediamine) is disclosed in WO 97/48787. Other suitable trispicens are described in WO 02/077145 and EP 1001009A.

Preferably, the ligand is selected from dimethyl 2,4-di-(2-pyridyl)-3-methyl-7-(pyridin-2-ylmethyl)-3,7-diaza-bicyclo[3.3.1]nonan-9-one-1,5-dicarboxylate, dimethyl 2,4-di-(2-pyridyl)-3-methyl-7-(N,N-dimethyl-amino-ethyl)-3,7-diaza-bicyclo[3.3.1]nonan-9-one-1,5-dicarboxylate, 5,12-dimethyl-1,5,8,12-tetraaza-bicyclo[6.6.2]hexadecane, 5,12-dibenzyl-1,5,8,12-tetraaza-bicyclo[6.6.2]hexadecane, N,N-bis(pyridin-2-yl-methyl-1,1-bis(pyridin-2-yl)-1-aminoethane, and N,N-bis(pyridin-2-yl-methyl-1,1-bis(pyridin-2-yl)-2-phenyl-1-aminoethane.

### Other Ligands

Other polydentate accelerant ligands known to those in the art may also be used, and these are discussed below. Typically, these ligands may be used in pre-formed transition metal complexes, which comprise the polydentate accelerant ligand.

Firstly, the polydentate accelerant ligand may be a bidentate nitrogen donor ligand, such as 2,2′-bipyridine or 1,10-phenanthroline, both of which are used known in the art as polydentate accelerant ligands in siccative metal driers. Often 2,2′-bipyridine or 1,10-phenanthroline are provided as ligands in manganese- or iron-containing complexes. Other bidentate polydentate accelerant ligands include bidentate amine-containing ligands. 2-aminomethylpyridine, ethylenediamine, tetramethylethylene-diamine, diaminopropane, and 1,2-diaminocyclohexane.

A variety of bi- to hexadentate oxygen donor-containing ligands, including mixed oxygen- and nitrogen-containing donor ligands, are also known. For example, WO 03/029371 A1 describes tetradentate diimines of the formula:

R₁—C(A₁-O)═N—R₂—N═C(A₂-O)—R₃

wherein:
A₁ and A₂ both are aromatic residues;
R₁ and R₃ are covalently bonded groups, for example hydrogen or an organic group; and
R₂ is a divalent organic radical.

The use of 1,3-diketones as polydentate accelerant ligands is described in both EP 1382648 A1 and WO 00/11090 A1, EP 1382648 also describing the use of complexes comprising 1,3-diketones (or 1,3-diimines) and bidentate diamines, including bipyridine and phenanthroline.

A variety of metal driers are described in US 2005/0245639, including vanadium, manganese, iron, cobalt, cerium and lead complexes, including those containing imidazoles and pyrazoles such as those described in WO 00/11090, and aromatic and aliphatic amines.

Of the non-bispidon type siccatives the following are most preferred: 5,12-dimethyl-1,5,8,12-tetraaza-bicyclo[6.6.2]hexadecane, 5,12-dibenzyl-1,5,8,12-tetraaza-bicyclo[6.6.2]hexadecane, 1,4,8,11-tetraazacyclotetradecane, 1,4,8,11-tetramethyl-1,4,8,11-tetraazacyclotetradecane, 1,4,7,10-tetraazacyclododecane, 1,4,7,10-tetramethyl-1,4,7,10-tetraazacyclododecane, and 1,4,7,10-tetrakis(pyridine-2ylmethyl)-1,4,7,10-tetraazacyclododecane, N,N-bis(pyridin-2-yl-methyl)-bis(pyridin-2-yl)methylamine, N,N-bis(pyridin-2-yl-methyl-1,1-bis(pyridin-2-yl)-1-aminoethane, N,N-bis(pyridin-2-yl-methyl-1,1-bis(pyridin-2-yl)-2-phenyl-1-aminoethane and 1,4,7-trimethyl-1,4,7-triazacyclononane.

According to embodiments of the present invention, the oxidatively curable water-based coating agent compositions of the invention may contain an antiskinning compound or antioxidant. Examples include, but are not limited to, methylethylketoxime, acetonoxime, butyraldoxime, dialkylhydroxylamine, ascorbic acid, isoascorbate materials as described in WO 2007/024582, acetylacetonate, ammonia, vitamin E (tocopherol), hydroxylamine, triethylamine, dimethylethanolamine, o-cyclohexylphenol, p-cyclohexylphenol and 2-t-butyl-4-methylphenol. In some embodiments, where an antiskinning compound is present this is methylethylketoxime, acetonoxime, butyraldoxime, dialkylhydroxylamine, ammonia, hydroxylamine, triethylamine, dimethylethanolamine, o-cyclohexylphenol, p-cyclohexylphenol, 2-t-butyl-4-methylphenol, or a mixture thereof.

Where present, the concentration of antioxidant or antiskinning compound applied is preferably between about 0.001 and about 2 wt %.

Additionally, one or more auxiliary driers (sometimes referred to as secondary driers) may be present in the curable composition. These may include fatty acid soaps of zirconium, bismuth, barium, vanadium, cerium, calcium, lithium, potassium, aluminum, strontium, and zinc. Preferred fatty acid soaps are octoates, neodecanoates, optionally alkyl-substituted hexanoates and naphthenates. Preferred metal ions in these soaps are zirconium, calcium, strontium and barium. Often such auxiliary driers advantageously diminish the effect of adsorption of the main metal drier on any solid particles often present in the curable composition. Other non-metal based auxiliary driers may also be present if desired. Typical concentrations of these auxiliary dryers are between about 0.01 wt % and about 2.5 wt %.

The coating composition may furthermore contain one or more additives conventionally found in curable coating compositions, such as, but not limited to: UV stabilisers, dispersants, surfactants, inhibitors, fillers, antistatic agents, flame-retardants, lubricants, antifoaming agents, antifouling agents, bactericides, fungicides, algaecides, insecticides, extenders, plasticisers, antifreezing agents, waxes and thickeners.

In certain embodiments, the coating compositions of the present invention comprise at least one colorant. The colorant component of the coating composition may comprise one or more inorganic or organic, transparent or non-transparent pigments. Non-limiting examples of such pigments are titanium dioxide, iron oxides, mixed metal oxides, bismuth vanadate, chromium oxide green, ultramarine blue, carbon black, lampblack, monoazo and diazo pigments, anthraquinones, isoindolinones, isoindolines, quinophthalones, phthalocyanine blues and greens, dioxazines, quinacridones and diketo-pyrrolopyrroles; and extender pigments including ground and crystalline silica, barium sulfate, magnesium silicate, calcium silicate, mica, micaceous iron oxide, calcium carbonate, zinc oxide, aluminum hydroxide, aluminum silicate and aluminum silicate, gypsum, feldspar, talcum, kaolin, and the like. The amount of pigment that is used to form the coating composition is understood to vary, depending on the composition application, and can be zero when a clear composition is desired.

The composition according to the invention can be used as a clear varnish or may contain pigments. Examples of pigments suitable for use are metal oxides, such as titanium dioxide or iron oxide, or other inorganic or organic pigments.

The coating composition may furthermore contain one or more additives such as UV stabilisers, cosolvents, dispersants, surfactants, inhibitors, fillers, anti-static agents, flame-retardant agents, lubricants, anti-foaming agents, extenders, plasticisers, anti-freezing agents, waxes, thickeners, thixotropic agents, etc. Furthermore, the coating composition according to the invention may optionally comprise various anti-oxidants and anti-skinning agents known in the art of the formulation of coating compositions, for example: phenol derivatives, e.g. pyrogallol, 2,6-di-tert.butylhydroxytoluene, hydroquinone, octadecyl-3-(3,5-di-tert.butyl-4-hydroxyphenyl)propionate—Irganox® 1076 (available from Ciba SC), bis(2-mercapto-ethyl)-(3-(3,5-di-tert.butyl-4-hydroxyphenyl)propionate) sulphide—Irganox® 1035 (available from Ciba SC), monomethyl ether of hydroquinone, propenyl phenol, 4-acetoxystyrene, iso-eugenol, lauryl gallate; sulphides, e.g. phenothiazine, dodecylsulphide, di(dodecyl)thiodipropionate; phosphines, e.g. trimethylphosphine, tri-n.octylphosphine, triphenylphosphine; phosphites, e.g. trimethylphosphite, triphenylphosphite, tris(nonylphenyl)phosphite, ethyl-bis(2,4-di-tert.butyl-6-methylphenyl)phosphite—Irgafos® 38 (available from Ciba SC), tris(2,4-di-tert.butylphenyl)phosphite—Irgafos® 168 (available from Ciba SC), bis(2,4-di-tert.butylphenyl)pentadiphosphite—Ultranox® 626 (available from General Electric); phosphonites, e.g. tetrakis(2,4-di-tert. butylphenyl)(1,1-biphenyl)-4,4′-diylbisphosphonite—Irgafos® P-EPQ (available from Ciba SC); dioxo-compounds, e.g. 2,4-pentanedione, dibenzoylmethane, 2,4-hexanedione, 1,3-cyclohexanedione, oxopropionic acid, 2-methyl-3-oxosuccinic acid diethyl ester, oxalacetic acid; oximes, e.g. butanone oxime, butyraldehyde oxime, cyclohexanone oxime; hydroxyacetone, diethylhydroxylamine, 3,5-dimethylpyrazole, ascorbic acid, Hindered Amine Light Stabilisers (HALS), e.g. Tinuvin® 123 and Tinuvine® 292 (available from Ciba SC), 2,3-butenediol, dibenzoyloxybutene, dibenzylthiocarbamic acid zinc salt, Vitamin E, Vitamin E acetate, hypophosphorous acid, 2-butylbenzofuran, 3,4-dihydro-2-ethoxy-2H-pyran, dodecylmercaptane, dicyclopentadiene.

The curable coating composition according to the various aspects of the invention may be used as a decorative coating, e.g., applied to wood substrates, such as door or window frames, or for other substrates such as those made of synthetic materials (such as plastics including elastomeric materials), concrete, leather, textile, glass, ceramic or metal. The curable coating composition according to the various aspects of the invention may be used as an industrial coating, e.g., applied to metal substrates, such as for automotive parts, bridges, equipment or for coil coatings. Thus, the invention also provides a method comprising applying to a substrate a composition according to the second aspect, or obtainable according to the first or third aspects, to a substrate. The thus applied composition may then be allowed to cure. The invention also provides a composition according to the second aspect, or obtainable according to the first or third aspects, when cured.

Thus, the invention also provides a method comprising applying to a substrate a composition according to the second aspect, or obtainable according to the first or third aspects, to a substrate. The thus applied composition may then be allowed to cure. The invention also provides a composition according to the second aspect, or obtainable according to the first or third aspects, when cured.

Any known method can be used to apply the coating compositions of the invention to a substrate. Non-limiting examples of such application methods are spreading (e.g., with paint pad or doctor blade, or by brushing or rolling), spraying (e.g., air-fed spray, airless spray, hot spray, and electrostatic spray), flow coating (e.g., dipping, curtain coating, roller coating, and reverse roller coating), and electrodeposition. (See generally, R. Lambourne, Editor, Paint and Surface Coating: Theory and Practice, Eilis Horwood, 1987, page 39 et seq.).

The coating compositions of the present invention can be applied and fully cured at ambient temperature conditions in the range of from about −10° C. to 50° C. Curing of said polymer composition according to the invention typically can proceed very rapidly, and in general can take place at a temperature within the range of from −10° C. to +50° C., in particular from 0° C. to 40° C., more in particular from 3° C. to 25° C. However, compositions of the present invention may be cured by additional heating.

The coating compositions of the present invention may be used as a single coating, a top coating, a base coating in a two-layered system, or one or more layers of a multi-layered system including a clear top coating composition, colorant layer and base coating composition, or as a primer layer. A typical opaque system may comprise: 1 or 2 layers of primer and 1 or 2 layers of topcoat (a total of 3 layers). Alternative opaque systems may comprise: 1 primer layer, 1 layer of midcoat and 1 layer topcoat. Examples of transparent systems may comprise 1 layer of impregnant and 3 layers of topcoats or 3 layers of topcoat for maintenance work.

The invention will be more readily understood by reference to the following examples, which are included merely for purpose of illustration of certain aspects and embodiments of the present invention and are not intended to limit the invention.

As used in this application, BOC is iron(1+), chloro[dimethyl 9,9-dihydroxy-3-methyl-2,4-di(2-pyridinyl-kN)-7-[(2-pyridinyl-kN)methyl]-3,7-diazabicyclo[3.3.1]nonane-1,4-dicarboxylate-kN3,kN7]-, chloride(1:1) illustrated below.

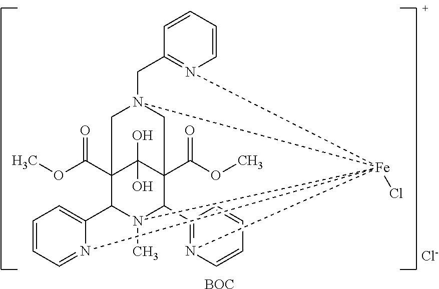

As used herein, TMTACN is 1,4,7-trimethyl-1,4,7-triazonane illustrated below.

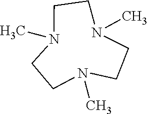

As used herein, Borchi® Dragon is a product from Borchers containing manganese neodecanoate and TMTACN. It is a high-performance, cobalt-free metal-ligand catalyst which demonstrates excellent drying performance in solvent-based and high solids alkyd resins. In appearance, it is a brown to amber liquid with a viscosity Max. of 100 mPa-s (informative) ISO 3219 (A) (20° C.) and a density of approx. 0.88 g/cm3 (informative) ISO 2811-2 (20° C.).

As used herein, a Lewis Acid accepts pairs of electrons. A Lewis acid is therefore any substance, that can accept a pair of nonbonding electrons. In other words, a Lewis acid is an electron-pair acceptor. One advantage of the Lewis theory is the way it complements the model of oxidation-reduction reactions. As used herein, Oxidation-reduction reactions involve a transfer of electrons from one atom to another, with a net change in the oxidation number of one or more atoms.

The Lewis theory suggests that acids react with bases to share a pair of electrons, with no change in the oxidation numbers of any atoms. Many chemical reactions can be sorted into one or the other of these classes. Either electrons are transferred from one atom to another, or the atoms come together to share a pair of electrons. The principal advantage of the Lewis theory is the way it expands the number of acids and therefore the number of acid-base reactions. In the Lewis theory, an acid is any ion or molecule that can accept a pair of nonbonding valence electrons. For example, A13+ ions form bonds to six water molecules to give a complex ion.

Al³⁺(aq)+6H₂O(l) [symbol] Al(H₂O)₆³⁺(aq)

This is an example of a Lewis acid-base reaction. The Lewis structure of water suggests that this molecule has nonbonding pairs of valence electrons and can therefore act as a Lewis base.

Thus, the Al(H₂O)₆³⁺ ion is formed when an Al³⁺ ion acting as a Lewis acid picks up six pairs of electrons from neighboring water molecules acting as Lewis bases to give an acid-base complex, or complex ion.

Lewis Acids are chemical species which have empty orbitals and are able to accept electron pairs from Lewis bases.

Water and some other compounds are considered as both Lewis acids and bases since they can accept and donate electron pairs based on the reaction.

Exemplary and non-limiting examples of Lewis Acids useful in practicing the invention include, but are not limited to: At least two Lewis acids and preferably mixtures and blends of at least two or more Lewis Acids having one or more of the following characteristics;
i. The at least two Lewis Acids being preferably Lewis Acid halides or acetates;
ii. The at least two Lewis Acid halides or acetates preferably based on Al and K salts used in combination;
iii. Synergies may also include other combinations of Lewis Acid metals, such as those in the following IUPAC groups of the Periodic Table (with the old IUPAC name in parenthesis):
   (a) Group 1 (Group IA alkali metals in the Li family, namely Li, Na, K, Rb, & Cs);
   (b) Group 2 (Group IIA, alkaline earth metals in the Be family, namely Be, Mg, Ca, Sr & Ba;
   (c) Group 3 (Group IIIA, transition metals in the Sc family, namely Sc & Y);
   (d) Group 4 (Group IVA, transition metals in the Ti family, namely Ti, Zr & Hf;
   (e) Group 12 (Group IIB, volatile metals in the Zn family, namely Zn & Cd);
   (f) Group 13 (Group IIIB, icoasagens of the B family, namely B, Al, Ga & In) and
   (g) Groups 4-12 of Row 4 (i.e., Sc, Ti, V, Cr, Mn, Fe, Co, Ni, Cu and Zn); and
   (h) the Lanthanide series (i.e., La, Ce, Pr, Nd, Pm, Sm, Eu, Gd, Tb, Dy, Ho, Er, Tm, Yb and Lu).

### Experimental Methods Used.

### Sample Preparation:

All the ingredients of a specific formulation were poured into a 50 ml polypropylene mixing cups. The polypropylene mixing cups were then placed in a DAC 150.1 FVZ speed mixer and mixed at 2000 rpm speed for 2 minutes. After the mixing, the samples were stored in the laboratory, at room temperature for 24 hours prior any testing.

Unless otherwise stated, the mass of Borchi® Oxy Coat (BOC) and Borchi® Dragon was 1% based on resin solids and was calculated as explained in Equation 1 below:

$${m}_{BOC or Borchi Dragon} = \frac{α {m}_{resin} \times 1}{100}$$

where a is the fraction solid content of the resin (for example, using 0.5 for 50%), mᵣₑₛᵢₙ the mass of the resin used, and 1 is a figure that corresponds to the loading level of BOC, in this case as 1% wt of BOC or Borchi Dragon on resin solids.

Unless otherwise stated, the mass of Borchers® Deca Cobalt 7 aqua, was calculated as metal on resin solids, and was calculated according to Equation 2 below:

$${m}_{Catalyst} = \frac{α {m}_{r e s i n} \times β}{γ}$$

ehere α is the solid content of the resin as a percent, mᵣₑₛᵢₙ the mass of the resin, γ the percentage of catalyst used and β is the metal content in % of the selected catalyst.

For Borchers® Deca Cobalt 7 acqua, α=0.07% and β=0.03 to 0.08, γ=7%.

Unless otherwise stated, all the values of formulation Tables refers to mass in gram (g), the values of hardness Tables are in seconds (s) and the values of dry time in the tables are in hours (h).

### Dry Time Recording:

To monitor the drying time of the coatings, B.K drying recorders were used. The solution was coated on a glass stripes using a manual film applicator of 100 μm. The drying recorder was run for 24 h. After 24 h, drying time was assessed with the graduation scale (according to traverse 24 h speed configuration). 6 samples were tested simultaneous. Each sample was repeated twice. The measurement was performed in a climate-controlled room at 23° C. and 50% humidity. The Set to touch (ST), Tack free (TF) and Dry hard (DH) times were then evaluated.

### Kônig Pendulum Hardness Measurement:

The pendulum hardness was measured using a TQC Sheen Pendulum Hardness Tester. It defined hardness by the Konig method as described in ISO 1522. Konig method worked on the principle that the damping time of a pendulum oscillating on a sample indicated the hardness. The TQC tester was calibrated using a glass calibration panel (VF2063, 250+/−10 seconds—König method). SP0505 Konig Pendulum was used. These measurements were performed in the climate-controlled room at 23° C. and 50% humidity. The coated panels (100 μm wet film thickness) were stored in this climate room prior the hardness measurement. The hardness was measured on three different points of the coated plate, and the average value of those points is reported, generally, after 1 day, 7 days and 14 days dry time.

### Glossary

| | Shorthand |
|---|---|
| Chemical or Brand Name | Notation |
| Borchers ® Deca Cobalt 10 | Deca Co 10 |
| Cobalt drier for solvent-based paint systems, a clear, | |
| low-viscous, blue-violet liquid with a Co metal content | |
| of between 9.80-10.20% ISO 4619; a non-volatile content | |
| between 48.00-58.00% ISO 3251 (2 g, 3 h, 105° C.); a | |
| viscosity max. 200 mPa · s (20° C.) ISO 3219 (A) | |
| and a density between 0.940-0.980 g/cm³ | |
| DIN 51757 (20° C.) | |
| Product from Borchers containing manganese | Borchi |
| neodecanoate and TMTACN | Dragon |
| 1,4,7-trimethyl-1,4,7-triazacyclononane | TMTACN |
| Borchi ® Oxy Coat, Borchi ® Oxy Coat 1101, they are | BOC or |
| made from dilutions of the active compound: Iron(1+), | BOC 1101 |
| chloro[dimethyl-9,9-dihydroxy-3-methyl-2,4-di-(2- | |
| pyridinyl-kN)-7-[(2-pyridinyl-kN)methyl]-3,7- | |
| diazabicyclo[3.3.1]nonane-1,5-dicarboxylate-kN3, | |
| kN7]-, chloride(1−) CAS 478945-46-9 | |
| Medium oil alkyd latex | Beckosol Aq |
| | 206 |
| Zirconium drier designed for water-based systems and | Octa-Soligen |
| is a clear, low-viscous, colorless to yellowish liquid | Zr 10 aqua |
| having a Zr Metal content between 9.80-10.20% ISO | |
| 4619; a viscosity max. 150 mPa · s (20° C.) ISO | |
| 3219 (A); and a density between 1.000-1.050 g/cm³ | |
| DIN 51757 (20° C.); solvent water. | |
| Copper salt of neodecanoic acid (neodecanoates) | Deca Cu |
| Active on Resin Solids | AOR |
| Metal on Resin Solids | MOR |
| Cobalt salt of neodecanoic acid (neodecanoates) | Co Deca 7 |
| | aqua |
| Aluminum carboxylate | AOC |
| Zinc drier for water-based systems having a clear, low- | Deca Zinc |
| viscous, colorless to yellowish liquid appearance, a Zn | 10 Aqua |
| metal content between 9.80-10.20% ISO 4619, a | |
| viscosity between 70-250 mPa · s (20° C.) ISO 3219 | |
| (A), a density between 0.980-1.020 g/cm³ | |
| DIN 51757 (20° C.) solvent water. | |
| Highly reactive tin-free catalyst for one- and two- | Borchi Kat |
| component polyurethane systems and RTV silicones | 315 EU |
| having a metal content of Bi between 15.80-16.20% | |
| Bi, ISO 4619; a non-volatile content between 50.0- | |
| 60.0% ISO 3251 (2 g, 3 h, 105° C.); a viscosity max. | |
| 2500 mPa · s 20° C., ISO 3219 and a density between | |
| 1.080-1.120 g/cm³ 20° C., DIN 51757. | |

TABLE I

| | Beckosol | Co Deca 7 | | | | AlCl₃•6H₂O (11.2%) | | KCl (53%) | | | | | Pendulum | |
|---|---|---|---|---|---|---|---|---|---|---|---|---|---|---|
| | AQ 206 | aqua | | BOC1101 | | 10% in water | | 10% in water | | Drying time (h) 22.2° C. | | | hardness/s | |
| Exp | mass | % | mass | % | mass | % | mass | % | mass | 25% humidity | | | 1 | 7 |
| # | (g) | MOR | (g) | MOR | (g) | MOR | (g) | MOR | (g) | ST | TF | DH | day | days |
| 1 | 28 | 0 | 0 | 0.6100 | 0.0940 | 0.3000 | 4.1267 | 0.0900 | 0.2616 | 0.5 | 8 | 15 | 16.7 | 28.9 |
| | | | | | | | | | | 0.25 | 11 | 17 | | |
| 2 | 28 | 0 | 0 | 0.6100 | 0.0940 | 0 | 0 | 0 | 0 | 0.5 | 3 | 11 | 18.6 | 22.4 |
| | | | | | | | | | | 0.5 | 2 | 12 | | |
| 3 | 28 | 0 | 0 | 0.6100 | 0.0940 | 0.3000 | 4.1280 | 0 | 0 | 0.5 | 25 | 25 | 16.7 | 21.8 |
| | | | | | | | | | | 0.5 | 25 | 25 | | |
| 4 | 28 | 0 | 0 | 0.6100 | 0.0940 | 0 | 0 | 0.0900 | 0.2616 | 0.5 | 16 | 17 | 18.1 | 22.3 |
| | | | | | | | | | | 0.5 | 13 | 15 | | |
| 5 | 28 | 0.15 | 0.33 | 0 | 0 | 0 | 0 | 0 | 0 | 0.5 | 1.5 | 5 | 20.9 | 29.4 |
| | | | | | | | | | | 0.5 | 1.5 | 7 | | |
| 6 | 28 | 0.15 | 0.33 | 0 | 0 | 0.3000 | 4.1258 | 0.0900 | 0.2616 | 0.25 | 25 | 25 | 10.1 | 18.5 |
| | | | | | | | | | | 0.25 | 25 | 25 | | |
| 7 | 28 | 0.15 | 0.33 | 0 | 0 | 0.3000 | 4.1299 | 0 | 0 | 0.5 | 25 | 25 | 13.0 | 21.0 |
| | | | | | | | | | | 0.5 | 25 | 25 | | |
| 8 | 28 | 0.15 | 0.33 | 0 | 0 | 0 | 0 | 0.0900 | 0.2616 | 0.5 | 2 | 12 | 22.4 | 29.8 |
| | | | | | | | | | | 0.5 | 1.75 | 12 | | |

TABLE II

| | | | | | | AlCl₃•6H₂O | | Cul (0.3337% | |
|---|---|---|---|---|---|---|---|---|---|
| | | Co Deca 7 | | | | (11.2%) 10% | | metal) 1% | |
| BOC 1101 | | aqua | | 7% AOC | | in water | | in ACN | |
| % | mass | % | mass | % | mass | % | mass | % | mass |
| MOR | (g) | MOR | (g) | MOR | (g) | MOR | (g) | MOR | (g) |
| 1 | 0.11 | | | | | | | | |
| | | 0.05 | 0.0787 | | | | | | |
| | | | | 0.03 | 0.0477 | | | | |
| | | | | 0.40 | 0.6276 | | | | |
| | | | | | | 0.0300 | 0.1466 | | |
| | | | | | | 0.4000 | 1.9693 | | |
| | | | | | | | | 0.010 | 0.328 |
| | | | | | | | | 0.001 | 0.034 |
| 1 | 0.11 | | | 0.03 | 0.0471 | | | | |
| 1 | 0.11 | | | 0.40 | 0.6286 | | | | |
| 1 | 0.11 | | | | | 0.03 | 0.1476 | | |
| 1 | 0.11 | | | | | 0.40 | 1.9868 | | |
| 1 | 0.11 | | | | | | | 0.01 | 0.3295 |
| 1 | 0.11 | | | | | | | 0.001 | 0.0334 |
| 1 | 0.11 | | | | | | | | |
| 1 | 0.11 | | | | | | | | |
| 1 | 0.11 | | | | | | | | |
| 1 | 0.11 | | | | | | | | |

| | | | | Drying Time (Hr) | | | Pendulum | |
|---|---|---|---|---|---|---|---|---|
| Cu(Oac)₂ | | Deca Cu | | 22.2° C. | | | Hardness/s | |
| % | mass | % | mass | 25% humidity | | | 1 | 7 |
| MOR | (g) | MOR | (g) | ST | TF | DH | day | days |
| | | | | 0.75 | 2 | 7.5 | 19.6 | 23.8 |
| | | | | 0.5 | 2 | 17 | 20.4 | 34.1 |
| | | | | 0.5 | 25 | 25 | 9.7 | 15.4 |
| | | | | 0.25 | 22 | 25 | 13.5 | 16.3 |
| | | | | 0.5 | 25 | 25 | 7 | 14.0 |
| | | | | 0.5 | 25 | 25 | 7.4 | 14.3 |
| | | | | 0.5 | 10 | 19.5 | 19.6 | 25.6 |
| | | | | 0.5 | 19 | 25 | 12.5 | 19.9 |
| 0.010 | 0.070 | | | 0.5 | 9.5 | 13 | 18.7 | 23.3 |
| 0.001 | 0.007 | | | 0.5 | 25 | 25 | 11.2 | 20.1 |
| | | 0.01 | 0.0134 | 0.25 | 17 | 25 | 19.6 | 22.9 |
| | | 0.001 | 0.0015 | 0.25 | 25 | 25 | 11.6 | 19.1 |
| | | | | 0.5 | 4.5 | 8 | 19.1 | 21.0 |
| | | | | 0.75 | 3 | 7 | 16.8 | 20.0 |
| | | | | 0.5 | 1.5 | 8 | 19.5 | 25.2 |
| | | | | 0.5 | 6 | 9 | 20.9 | 28.8 |
| | | | | 0.5 | 1.25 | 12 | 19.5 | 26.6 |
| | | | | 0.5 | 1.5 | 8.5 | 20.3 | 28.9 |
| 0.01 | 0.0691 | | | 0.5 | 1.5 | 3 | 20.5 | 27.1 |
| 0.001 | 0.0069 | | | 0.5 | 1.5 | 2.5 | 19.1 | 23.7 |
| | | 0.01 | 0.0136 | 0.5 | 1.5 | 4.5 | 19.6 | 26.6 |
| | | 0.001 | 0.0015 | 0.5 | 1.5 | 3.75 | 18.1 | 22.4 |

What is illustrated in Table I is that Lewis Acid salts on their own are generally not very effective, with some exceptions, e.g., with copper-based materials. For BOC there is a special combination with AlCl₃ and KCl that brings the hardness levels of BOC up to those of cobalt driers (compare Exp #1 with #5). The combination of BOC with either AlCl₃ or KCl does not show any clear improvement over BOC alone (compare Exp. #2-#4). This synergy of BOC, AlCl₃ and KCl is not seen for Co (compare Exp. #5-#8). Furthermore, the salts used without primary driers have no appreciable effects. The advantage of this invention is that all cobalt is removed from the coatings. Furthermore, the amount of BOC can be reduced by adding in less expensive salts.

See also Table II where it is shown that copper can have a drying effect (ref), but that it yellows coatings considerably, which restricts its use in coatings. However, we looked to offset the slower drying performance of the AlCl₃ component by using a reduced concentration of with CuI or CuOAc₂. Surprisingly we see the same synergies as before, but the copper helps to boost the performance of BOC when we combine both KCl and AlCl₃. As expected, too much copper leads to serious discoloration, so the synergized blends help to reduce the amount of copper required.

It is known that copper can have a drying effect, but that it yellows coatings considerably, which restricts its use in coatings. However, the slower drying performance of the AlCl₃ component was offset by using a reduced concentration of with Cu(I) or Copper (II) acetate. Surprisingly the same synergies as before were seen, but the copper helps to boost the performance of BOC when both KCl and AlCl₃ were combined As expected, too much copper leads to serious discoloration, so the synergized blends help to reduce the amount of copper required.

In Table III the combinations of BOC1101, AlCl₃·6H₂O, KCl and Copper (II) acetate are shown. The active on resin solids (AOR) and the metal on resin solids (MOR) to total 1 in each run. The control for cobalt (Exp 1) gives a hardness of 30 s to 90 s over 4 weeks, for BOC (Exp 2) 32 s to 48 s over 4 weeks. It can be seen that the addition of Copper (II) acetate to BOC (Exp 5) improves hardness over BOC, but with AlCl₃ and Copper (II) acetate we see a reduction in hardness, no advantage (Exp 6). We also see only a small improvement when we combine KCl alone with BOC (Exp 4) or with KCl and Copper (II) acetate (Exp 7). Only a combination of KCl, AlCl₃ and CuOAc₂ (Exp 8) leads to a significantly improved hardness whilst maintaining a good dry time.

Furthermore, a high loading of AlCl₃ gives a high hardness but forms an insoluble mixture and increases dry time (Exp 3). A high loading of Copper (II) acetate improves dry time and hardness of BOC but the high copper loading leads to significant yellowing, which is undesirable in some coatings (Exp 5).

What has been shown above is that the Lewis Acid halide salts can boost BOC hardness without having a significant effect on dry time when used together, and that the effect can be further enhanced by adding Copper (II) acetate. We have also seen a similar advantage by using copper halide salts, such as Copper (I) iodide, in place of Copper (II) acetate, to help reduce dry time.

TABLE III

| | | | | | | AlCl₃•6H₂O | | | |
|---|---|---|---|---|---|---|---|---|---|
| | Beckosol | Deca Co 7 | | | | (11.2%) 10% | | KCl(53%) | |
| | AQ 206 | Aqua | | BOC1101 | | in water | | 10% in water | |
| Exp | mass | % | mass | % | mass | % | mass | % | mass |
| # | (g) | AOR | (g) | AOR | (g) | MOR | (g) | MOR | (g) |
| 1 | 28 | 0.15 | 0.33 | 0 | 0 | 0 | 0 | 0 | 0 |
| 2 | 28 | 0 | 0 | 0.500 | 0.0770 | 0 | 0 | 0 | 0 |
| 3 | 28 | 0 | 0 | 0.720 | 0.1109 | 0.280 | 3.8500 | 0 | 0 |
| 4 | 28 | 0 | 0 | 0.700 | 0.1078 | 0 | 0 | 0.300 | 0.8717 |
| 5 | 28 | 0 | 0 | 0.724 | 0.1115 | 0 | 0 | 0 | 0 |
| 6 | 28 | 0 | 0 | 0.617 | 0.0950 | 0.140 | 0.1922 | 0 | 0 |
| 7 | 28 | 0 | 0 | 0.600 | 0.0924 | 0 | 0 | 0.198 | 0.5765 |
| 8 | 28 | 0 | 0 | 0.721 | 0.1110 | 0.080 | 0.1100 | 0.195 | 0.5675 |

| | Cu(II) acetate | | | | | | | | |
|---|---|---|---|---|---|---|---|---|---|
| | (31.8%) 5% | | | | | Pendulum | | | |
| | in water | | | | | hardness | | | |
| Exp | % | mass | Drying time | | | 1 | 7 | 4 | |
| # | MOR | (g) | ST | TF | DH | day | days | weeks | Yellowing |
| 1 | 0 | 0 | 0.5 | 0.75 | 1.75 | 30 | 50 | 90 | Slightly |
| | | | | | | | | | yellowing |
| | | | 0.5 | 0.75 | 2 | | | | |
| 2 | 0 | 0 | 0.5 | 1.8 | 2 | 32 | 32 | 48 | No |
| | | | | | | | | | yellowing |
| | | | 0.5 | 1.0 | 3 | | | | |
| 3 | 0 | 0 | 0.25 | 5 | 11 | 41 | 51 | 78 | No |
| | | | | | | | | | yellowing |
| | | | 0.25 | 5 | 11.5 | | | | |
| 4 | 0 | 0 | 0.25 | 2 | 4 | 43 | 42 | 65 | No |
| | | | | | | | | | yellowing |
| | | | 0.25 | 2 | 3.5 | | | | |
| 5 | 0.276 | 2.6724 | 0.5 | 1.25 | 2 | 45 | 56 | 73 | Strong |
| | | | | | | | | | yellowing |
| | | | 0.5 | 1.5 | 2.5 | | | | |
| 6 | 0.243 | 2.3554 | 0.25 | 1 | 1.5 | 36 | 40 | 60 | Yellowish |
| | | | 0.25 | 1 | 2 | | | | |
| 7 | 0.202 | 1.9525 | 0.25 | 1.75 | 4 | 32 | 41 | 62 | Yellowish |
| | | | 0.25 | 1.5 | 4.5 | | | | |
| 8 | 0.004 | 0.0354 | 0.25 | 1.5 | 6 | 43 | 46 | 70 | No |
| | | | | | | | | | yellowing |
| | | | 0.5 | 2.5 | 5.5 | | | | |

What has also been observed is that the use of KCl gave an advantage in stability over commercially available potassium driers such as potassium 2-ethylhexanoate. While stable mixtures were obtained with KCl, the use of potassium 2-ethylhexanoate in the tested mixtures often led to precipitation.

### Experimental

Example Catalyst Mixture Preparation Using BOC with AlCl₃·6H₂O and KCl

10 wt % aq. solution of AlCl₃·6H₂O was prepared by dissolving 20 g AlCl₃·6H₂O in 180 g distilled water. The other solutions were prepared in the same way.

A vial was then charged with 0.0940 g BOC1101 (0.61% AOR), 4.1267 g of a 10 wt % aq. solution of AlCl₃·6H₂O (1.1% metal content, 0.30% MOR) and 0.2616 g of a 10% aq. solution of KCl (5.2% metal content, 0.09% MOR). This solution was then well mixed, and then added to the binder (see example paint preparation). The components can also be added separately to the paint, with all components mixed together using the SpeedMixer. We see similar data regardless of preparation method.

### Example Paint Preparation

The catalyst mixture was charged to a 60 ml plastic vial. To this, we added 28 g of Beckosol AQ 206 (55% solid content), sealed the vial and then mixed at 2000 rpm for two minutes in in a high-speed mixer (SpeedMixer DAC 150.1 FVZ). The resulting paint and catalyst mixture was stored under ambient conditions for 24 hours before the films were cast onto a glass substrate (i.e. a 30×2.4 cm plate for drytime recording measurements) using a 100 μm steel cube applicator.

### Dry Time Recording

“B.K. drying recorders model 3” (The Mickle laboratory engineering Co Ltd.) dry time recorder were used to measure the time required to reach the three drying states of (i) set-to-touch (ST), which means the paint no longer flows back after the needle has passed through; tack-free (TF) where tearing of the coating is created by the needle, and (iii) dry-hard (DH), where the coating is no longer marked by the needle—further explained in ASTM method D5895-13.

The coated glass plate was placed on the dry time recorder, a needle was put on the film, the recorder was set for measurement over 24 hours. We then started the drytime recorder—the starting point is designated by where the needle was put onto the film—this was marked on the glass using a pen. The three drying phases were identified by the typical flow patterns given at each stage, and the time for completion at each stage was recorded.

### König Pendulum Hardness

Films of 100 μm thickness were cast on broader glass sheets (15×9 cm) for measurement of hardness at the same time as when casting films for dry time recording. These were evaluated on a pendulum hardness tester after drying times of 24 hours, 7 days and 14 days. Pendulum hardness was measured on a TQC Sheen Pendulum Hardness Tester SP0500 by using the Konig method (measuring the time of oscillations in seconds, starting at an initial amplitude of 6° and until an amplitude of 3° is reached). Softer material dampens the pendulum's oscillations more quickly than harder material, so softer material has a lower hardness value in seconds than harder material.

In the following further embodiments are disclosed:

In a first embodiment, a process for improving the hardness of an aqueous alkyd resin coating is disclosed comprising the following steps, without regard to order, of:
adding at least one metal ligand complex wherein the metal is selected from the group consisting of Fe, V, Cu and Mn; and
adding at least one ligand selected from the group consisting of Bispidon, N4py type, TACN-type, Cyclam and cross-bridged ligands, and Trispicen-type ligands in either a preformed metal ligand complex of the metal and the ligand or formed in-situ as the metal ligand complex; and
adding at least two Lewis Acids, preferably two or more Lewis Acids, pre-blended or formed in-situ, the Lewis Acids comprising
   up to 1% metal on alkyd resin solids; and
   at least two Lewis acids and preferably mixtures and blends of at least two or more Lewis Acids having one or more of the following characteristics;
   the Lewis Acids being preferably Lewis Acid halides or acetates;
   the Lewis Acid halides or acetates preferably based on Al and K salts used in combination with optionally one or more of the following Groups of the Periodic Table;
      a) Group 1 (Group IA alkali metals in the Li family, namely Li, Na, K, Rb, & Cs);
      b) Group 2 (Group IIA, alkaline earth metals in the Be family, namely Be, Mg, Ca, Sr & Ba;
      c) Group 3 (Group IIIA, transition metals in the Sc family, namely Sc & Y);
      d) Group 4 (Group IVA, transition metals in the Ti family, namely Ti, Zr & Hf);
      e) Group 12 (Group IIB, volatile metals in the Zn family, namely Zn & Cd);
      f) Group 13 (Group IIIB, icoasagens of the B family, namely B, Al, Ga & In) and
      g) Groups 4-12 of Row 4 (i.e., Sc, Ti, V, Cr, Mn, Fe, Co, Ni, Cu and Zn); and
      h) the Lanthanide series (i.e., La, Ce, Pr, Nd, Pm, Sm, Eu, Gd, Tb, Dy, Ho, Er, Tm, Yb and Lu); and
      i) Bi.

In a second embodiment of the process of the first embodiment, the ligand is a bispidon ligand of Formula (I)

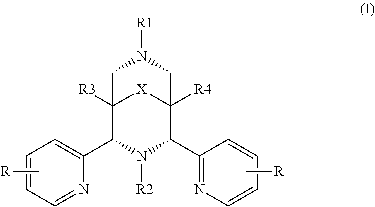

wherein:
each R is independently selected from the group consisting of hydrogen, F, Cl, Br, hydroxyl, C₁₋₄-alkylO—, —NH—CO—H, —NH—CO—C₁₋₄alkyl, —NH₂, —NH—C₁₋₄alkyl, and C₁₋₄alkyl;
R1 and R2 are independently selected from the group consisting of C₁₋₂₄alkyl, C₆₋₁₀aryl, and a group containing one or two heteroatoms (e.g. N, O or S) capable of coordinating to a transition metal;
R3 and R4 are independently selected from the group consisting of hydrogen, C₁₋₈alkyl, C₁-8alkyl-O—C₁₋₆alkyl, C₁₋₈alkyl-O—C₆₋₁₀aryl, C₆₋₁₀aryl, C₁₋₈hydroxyalkyl and —(CH₂)ₙC(O)OR5 wherein R5 is independently selected from hydrogen and C₁-4alkyl,
n is from 0 to 4
X is selected from the group consisting of C═O, —[C(R6)₂]_{y}— wherein y is from 0 to 3; and
each R6 is independently selected from the group consisting of hydrogen, hydroxyl, C₁₋₄ alkoxy and C₁₋₄ alkyl.

In a third embodiment of the process of the first embodiment, the ligand is a N4py-type ligand of Formula (II)

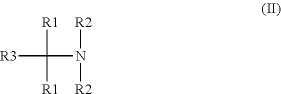

wherein:
each R1 and R2 independently represents —R4-R5;
R3 represents hydrogen, C₁₋₈-alkyl, aryl selected from homoaromatic compounds having a molecular weight under 300, or C₇₋₄₀ arylalkyl, or —R4-R5,
each R4 independently represents a single bond or a linear or branched C₁₋₈-alkyl-substituted-C₂₋₆-alkylene, C₂₋₆-alkenylene, C₂₋₆-oxyalkylene, C₂₋₆-aminoalkylene, C₂₋₆-alkenyl ether, C₂₋₆-carboxylic ester or C₂₋₆-carboxylic amide, and
each R5 independently represents an optionally N-alkyl-substituted aminoalkyl group or an optionally alkyl-substituted heteroaryl: selected from the group consisting of pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl.

In a fourth embodiment of the process of the first embodiment, the ligand is a TACN-type ligand of Formula (III)

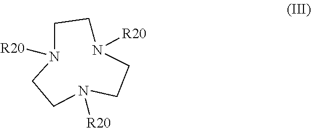

wherein
each R20 is independently selected from: C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, or C₇₋₄₀-arylalkyl group optionally substituted with a substituent selected from hydroxy, alkoxy, phenoxy, carboxylate, carboxamide, carboxylic ester, sulfonate, amine, alkylamine and N⁺(R21)₃,
R21 is selected from hydrogen, C₁₋₈-alkyl, C₂₋₆-alkenyl, C₇₋₄₀-arylalkyl, arylalkenyl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R22,
Y is independently selected from H, CH₃, C₂H₅, C₃H₇ and
R22 is independently selected from C₁₋₈-alkyl-substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl; and
   wherein at least one of R20 is a —CY₂-R22.

In a fifth embodiment of the process of the first embodiment, the ligand is a cyclam or cross-bridged ligand of Formula (IV)

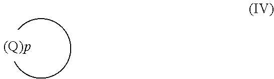

wherein:
Q is independently selected from

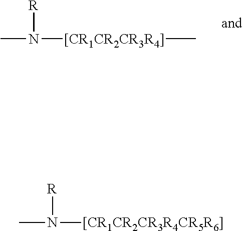

p is 4;
R is independently selected from: hydrogen, C₁₋₆-alkyl, CH₂CH₂OH, pyridin-2-ylmethyl, and CH₂OOOH, or one of R is linked to the N of another Q via an ethylene bridge; and
R₁, R₂, R₃, R₄, R₅ and R₆ are independently selected from: H, C₁₋₄-alkyl, and C₁₋₄-alkylhydroxy.

In a sixth embodiment of the process of the fifth embodiment, the cross-bridged ligand is of the formula (V):

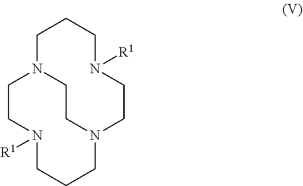

wherein
   R¹ is independently selected from H, C₁₋₂₀ alkyl, C₇₋₄₀-alkylaryl, C₂₋₆-alkenyl or C₂₋₆-alkynyl.

In a seventh embodiment of the process of the first embodiment, the ligand is a trispicen-type ligand formula (VI):

R17R17N—X—NR17R17 (VI),

wherein:
X is selected from —CH₂CH₂—, —CH₂CH₂CH₂—, —CH₂C(OH)HCH₂—;
each R17 Is independently represents a group selected from: R17, C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, and C₇₋₄₀ arylalkyl groups optionally substituted with a substituent selected from hydroxy, alkoxy, phenoxy, carboxylate, carboxamide, carboxylic ester, sulfonate, amine, alkylamine and N⁺(R19)₃, wherein
R19 is selected from hydrogen, C₁₋₈-alkyl, C₂₋₆-alkenyl, C₇₋₄₀-arylalkyl, C₇₋₄₀-arylalkenyl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂-R18, in which each Y is independently selected from H, CH₃, C₂H₅, C₃H₇; and
R18 is independently selected from an optionally substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl; and at least two of R17 are —CY₂—R18.

In an eighth embodiment of the process of claim 2, the bispidon ligand is iron(1+), chloro[dimethyl 9,9-dihydroxy-3-methyl-2,4-di(2-pyridinyl-kN)-7-[(2-pyridinyl-kN)methyl]-3,7-diazabicyclo[3.3.1]nonane-1,4-dicarboxylate-kN3,kN7]-, chloride(1:1)

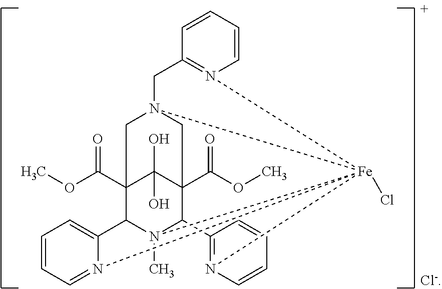

In a ninth embodiment of the process of the first embodiment, the metal-ligand complex is a combination blend of:
a 1,4,7-trimethyl-1,4,7-triazonane; and
at least two Lewis Acid metal halides comprising aluminum halide and potassium halide; and
a ratio of 1,4,7-trimethyl-1,4,7-triazonane to Lewis Acid metal halides ranging from 0.001 to 1,000/1 inclusive.

In a tenth embodiment of the process of the first embodiment, the Lewis Acid is a metal halide, a metal carboxylate or mixtures or blends thereof; or the Lewis Acid is an aluminum halide, a potassium halide or a copper carboxylate.

In an eleventh embodiment of the process of the tenth embodiment, the at least two Lewis Acid halides comprise metal halides and the metal of the Lewis Acid metal halide is selected from the group comprising aluminum and potassium.

In a twelfth embodiment, the process of the first embodiment further comprises the step of: adding at least one metal ligand complex and at least one Lewis acid alkyd-based paint formulation, an alkyd-based ink formulation or a composite or gel coating formulation based on unsaturated polyester resin, styrene or acrylate monomers, or vinyl ester resin; or optionally adding at least one additional step selected from the group consisting of: adding at least one antiskinning compound; adding one or more auxiliary driers or secondary driers; adding at least one UV stabilizer; adding at least one dispersant; adding at least one surfactant; adding at least one corrosion-inhibitor; adding at least one filler; adding at least one antistatic agent; adding at least one flame-retardant; adding at least one lubricant; adding at least one antifoaming agent; adding at least one antifouling agent; adding at least one bactericides; adding at least one fungicide; adding at least one algaecide; adding at least one insecticide; adding at least one extender; adding at least one plasticizer; adding at least one antifreezing agent; adding at least one wax; adding at least one thickener; and adding at least one pigment.

In a thirteenth embodiment, the process of the first embodiment, further comprises the step of: pre-combining the at least one metal ligand complex with the at least one Lewis acid prior to addition to the alkyd-based paint formulation; or includes the step of adding the at least one Lewis acid before the step of adding the metal ligand complex.

In a fourteenth embodiment, a coating composition is disclosed which comprises:
at least one metal wherein the metal is selected from the group consisting of Fe, V, Cu and Mn; and
at least one ligand selected from the group consisting of Bispidon, N4py type, TACN-type, Cyclam and cross-bridged ligands, and Trispicen-type ligands, said ligands added as an in-situ complex or as a pre-made complex with the at least one metal; and
at least two Lewis Acid halides with the proviso that the Lewis Acid halides comprise an aluminum halide and a potassium halide.

In a fifteenth embodiment of the coating composition of the fourteenth embodiment, the at least one ligand is selected from the group consisting of:

### (A) the Bispidon Ligand of Formula (I)

wherein:

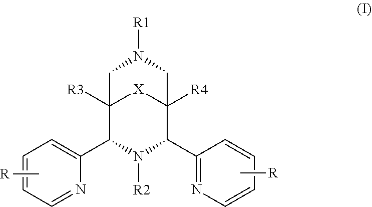

each R is independently selected from the group consisting of hydrogen, F, Cl, Br, hydroxyl, C₁₋₄-alkylO—, —NH—CO—H, —NH—CO—C₁₋₄alkyl, —NH₂, —NH—C₁₋₄alkyl, and C₁₋₄alkyl;
R1 and R2 are independently selected from the group consisting of C₁₋₂₄alkyl, C₆₋₁₀aryl, and a group containing one or two heteroatoms (e.g. N, O or S) capable of coordinating to a transition metal;
R3 and R4 are independently selected from the group consisting of hydrogen, C₁₋₈alkyl, C₁₋₈alkyl-O—C₁₋₈alkyl, C₁₋₈alkyl-O—C₆₋₁₀aryl, C₆₋₁₀aryl, C₁₋₈hydroxyalkyl and —(CH₂)ₙC(O)OR5 wherein R5 is independently selected from hydrogen and C₁₋₄alkyl,
n is from 0 to 4
X is selected from the group consisting of C═O, —[C(R6)₂]_{y}— wherein y is from 0 to 3; and
each R6 is independently selected from the group consisting of hydrogen, hydroxyl, C₁₋₄ alkoxy and C₁₋₄ alkyl.
   (B) the N4py-type ligand of Formula (II)

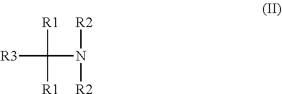

wherein:
each R1 and R2 independently represents —R4-R5;
R3 represents hydrogen, C₁₋₈-alkyl, aryl selected from homoaromatic compounds having a molecular weight under 300, or C₇₋₄₀ arylalkyl, or —R4-R5,
each R4 independently represents a single bond or a linear or branched C₁₋₈-alkyl-substituted-C₂₋₆-alkylene, C₂₋₆-alkenylene, C₂₋₆-oxyalkylene, C₂₋₆-aminoalkylene, C₂₋₆-alkenyl ether, C₂₋₆-carboxylic ester or C₂₋₆-carboxylic amide, and
each R5 independently represents an optionally N-alkyl-substituted aminoalkyl group or an optionally alkyl-substituted heteroaryl: selected from the group consisting of pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl.

### (C) The TACN-Type Ligand of Formula (III)

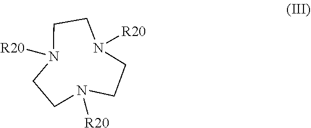

wherein
each R20 is independently selected from: C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, or C₇₋₄₀-arylalkyl group optionally substituted with a substituent selected from hydroxy, alkoxy, phenoxy, carboxylate, carboxamide, carboxylic ester, sulfonate, amine, alkylamine and N⁺(R21)₃,
R21 is selected from hydrogen, C₁₋₈-alkyl, C₂₋₆-alkenyl, C₇₋₄₀-arylalkyl, arylalkenyl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R22,
Y is independently selected from H, CH₃, C₂H₅, C₃H₇ and
R22 is independently selected from C₁₋₈-alkyl-substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl; and wherein at least one of R20 is a —CY₂—R22.

### (D) The Cyclam or Cross-Bridged Ligand of Formula (IV)

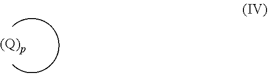

wherein:
Q is independently selected from

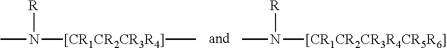

p is 4;
R is independently selected from: hydrogen, C₁₋₆-alkyl, CH₂CH₂OH, pyridin-2-ylmethyl, and CH₂OOOH, or one of R is linked to the N of another Q via an ethylene bridge; and
R₁, R₂, R₃, R₄, R₅ and R₆ are independently selected from: H, C₁₋₄-alkyl, and C₁₋₄-alkylhydroxy.
   (E) the cross-bridged ligand of the formula (V):

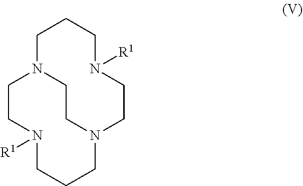

wherein
R¹ is independently selected from H, C₁₋₂₀ alkyl, C₇₋₄₀-alkylaryl, C₂₋₆-alkenyl or C₂₋₆-alkynyl.

### (F) The Ligand is a Trispicen-Type Ligand Formula (VI):

R17R17N—X—NR17R17 (VI),

wherein:
X is selected from —CH₂CH₂—, —CH₂CH₂CH₂—, —CH₂C(OH)HCH₂—;
each R17 independently represents a group selected from: R17, C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, and C₇₋₄₀ arylalkyl groups optionally substituted with a substituent selected from hydroxy, alkoxy, phenoxy, carboxylate, carboxamide, carboxylic ester, sulfonate, amine, alkylamine and N⁺(R19)₃, wherein
R19 is selected from hydrogen, C₁₋₈-alkyl, C₂₋₆-alkenyl, C₇₋₄₀-arylalkyl, C₇₋₄₀-arylalkenyl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R18, in which each Y is independently selected from H, CH₃, C₂H₅, C₃H₇ and R18 is independently selected from an optionally substituted heteroaryl: selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl; and at least two of R17 are —CY₂—R18.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A process for improving the hardness of an aqueous alkyd resin coating comprising the following steps, without regard to order, of:
adding at least one metal ligand complex comprising a metal and at least one ligand, wherein the metal is selected from the group consisting of Fe, V, Cu and Mn; and the at least one ligand is selected from the group consisting of Bispidon, N, N-bis(pyridin-2-yl-methyl)-bis(pyridin-2-yl)methylamine (N4py) type, 1,4,7-triazacyclononane (TACN)-type, 1,4,8,11-tetraazacyclotetradecane (Cyclam), cross-bridged ligands, and Trispicen-type ligands in either a preformed metal ligand complex of the metal and the at least one ligand or formed in-situ as the metal ligand complex; and
adding at least two Lewis Acids, pre-blended or formed in-situ, wherein:
the at least two Lewis Acids comprise up to 1% metal on alkyd resin solids;
the at least two Lewis acids have one or more of the following characteristics:
the Lewis Acids being preferably Lewis Acid halides or acetates;
the Lewis Acid halides or acetates preferably based on Al and K salts used in combination with optionally one or more of the following groups of the Periodic Table;
Group 1 (Group IA alkali metals in the Li family, namely Li, Na, K, Rb, Cs & Fr);
Group 2 (Group IIA, alkaline earth metals in the Be family, namely Be, Mg, Ca, Sr, Ba & Ra);
Group 3 (Group IIA, transition metals in the Sc family, namely Sc & Y);
Group 4 (Group IVA, transition metals in the Ti family, namely Ti, Zr & Hf);
Group 12 (Group IIB, volatile metals in the Zn family, namely Zn & Cd);
Group 13 (Group IIIB, icoasagens of the B family, namely B, Al, Ga & In);
Groups 4-12 of Row 4 (i.e., Sc, Ti, V, Cr, Mn, Fe, Co, Ni, Cu and Zn);
the Lanthanide series (i.e., La, Ce, Pr, Nd, Pm, Sm, Eu, Gd, Tb, Dy, Ho, Er, Tm, Yb and Lu); and
Bi (bismuth).

2. The process of claim 1 wherein
the at least one ligand is a bispidon ligand of Formula (I) 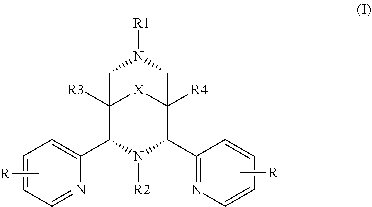
wherein:
each R is independently selected from the group consisting of hydrogen, F, Cl, Br, hydroxyl, C₁₋₄-alkylO—, —NH—CO—H, —NH—CO—C₁₋₄alkyl, —NH₂, —NH—C₁₋₄alkyl, and C₁₋₄alkyl;
R1 and R2 are independently selected from the group consisting of C₁₋₂₄alkyl, C₆₋₁₀aryl, and a group containing one or two heteroatoms (e.g. N, O or S) capable of coordinating to a transition metal;
R3 and R4 are independently selected from the group consisting of hydrogen, C₁₋₈alkyl, C₁₋₈alkyl-O—C₁-alkyl, C₁₋₈alkyl-O—C₆₋₁₀aryl, C₆₋₁₀aryl, C₁₋₈hydroxyalkyl and —(CH₂)ₙC(O)OR5 wherein R5 is independently selected from hydrogen and C₁₋₄alkyl and n is from 0 to 4;
X is selected from the group consisting of C═O, —[C(R6)₂]_{y}- wherein y is from 0 to 3; and
each R6 is independently selected from the group consisting of hydrogen, hydroxyl, C₁₋₄ alkoxy and C₁₋₄ alkyl.

3. The process of claim 1 wherein
the at least one ligand is a N4py-type ligand of Formula (II) 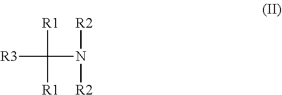
wherein:
each R1 and R2 independently represents —R4-R5;
R3 represents hydrogen, C₁₋₈-alkyl, aryl selected from homoaromatic compounds having a molecular weight under 300, or C₇₋₄₀ arylalkyl, or -R4-R5,
each R4 independently represents a single bond or a linear or branched C₁₋₈-alkyl-substituted-C₂₋₆-alkylene, C₂₋₆-alkenylene, C₂₋₆-oxyalkylene, C₂₋₆-aminoalkylene, C₂₋₆-alkenyl ether, C₂₋₆-carboxylic ester or C₂₋₆-carboxylic amide, and
each R5 independently represents an optionally N-alkyl-substituted aminoalkyl group or an optionally alkyl-substituted heteroaryl; selected from the group consisting of pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl.

4. The process of claim 1 wherein
the at least one ligand is a TACN-type ligand of Formula (III) 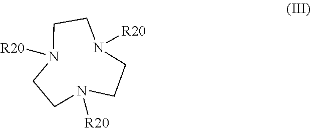
wherein
each R20 is independently selected from: hydrogen, —CY₂—R22, C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the selected heterocycloalkyl; heteroaryl selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl, aryl selected from homoaromatic compounds having a molecular weight under 300, or C₇₋₄₀-arylalkyl group optionally substituted with a substituent selected from hydroxy, alkoxy, phenoxy, carboxylate, carboxamide, carboxylic ester, sulfonate, amine, alkylamine and N⁺(R21)₃,
R21 is selected from hydrogen, C₁₋₈-alkyl, C₂₋₆-alkenyl, C₇₋₄₀-arylalkyl, arylalkenyl, C₁₋₈-oxyalkyl, C₂₋₆-oxyalkenyl, C₁₋₈-aminoalkyl, C₂₋₆-aminoalkenyl, C₁₋₈-alkyl ether, and C₂₋₆-alkenyl ether,
Y is independently selected from H, CH₃, C₂H₅, C₃H₇; and
R22 is independently selected from C₁₋₈-alkyl-substituted heteroaryl; selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the selected heteroaryl.

5. The process of claim 1 wherein
the at least one ligand is a cyclam or cross-bridged ligand of Formula (IV) 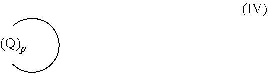
wherein:
Q is independently selected from 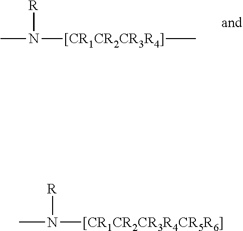
P is 4;
R is independently selected from: hydrogen, C₁₋₆-alkyl, CH₂CH₂OH, pyridin-2-ylmethyl, and CH₂COOH, or one of R is linked to the N of another Q via an ethylene bridge; and
R₁, R₂, R₃, R₄, R₅ and R₆ are independently selected from: H, C₁₋₄-alkyl, and C₁₋₄-alkylhydroxy.

6. The process of claim 5 wherein
the cross-bridged ligand is of the formula (V): 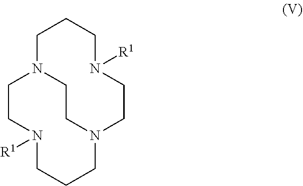
wherein
R¹ is independently selected from H, C₁₋₂₀ alkyl, C₇₋₄₀-alkylaryl, C₂₋₆-alkenyl or C₂₋₆-alkynyl.

7. The process of claim 1 wherein the at least one ligand is a trispicen-type ligand of formula (VI):
R17R17N—X—NR17R17 (VI),
wherein:
X is selected from —CH₂CH₂—, —CH₂CH₂CH₂—, —CH₂C(OH)HCH₂—;
each R17 independently represents a group selected from: —CY₂—R18, C₁₋₈-alkyl, C₃₋₈-cycloalkyl, heterocycloalkyl selected from the group consisting of: pyrrolinyl; pyrrolidinyl; morpholinyl; piperidinyl; piperazinyl; hexamethylene imine; 1,4-piperazinyl; tetrahydrothiophenyl; tetrahydrofuranyl; 1,4,7-triazacyclononanyl; 1,4,8,11-tetraazacyclotetradecanyl; 1,4,7,10,13-pentaazacyclopentadecanyl; 1,4-diaza-7-thia-cyclononanyl; 1,4-diaza-7-oxa-cyclononanyl; 1,4,7,10-tetraazacyclododecanyl; 1,4-dioxanyl; 1,4,7-trithia-cyclononanyl; tetrahydropyranyl; and oxazolidinyl, wherein the heterocycloalkyl may be connected to the compound via any atom in the ring of the heterocycloalkyl, heteroaryl selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl may be connected to the compound via any atom in the ring of the heteroaryl, aryl selected from homoaromatic compounds having a molecular weight under 300, and C₇₋₄₀ arylalkyl groups optionally substituted with a substituent selected from hydroxy, alkoxy, phenoxy, carboxylate, carboxamide, carboxylic ester, sulfonate, amine, alkylamine and N⁺(R19)₃, wherein
each R19 is independently selected from hydrogen, C₁₋₈-alkyl, C₂₋₆-alkenyl, C₇₋₄₀-arylalkyl, C₇₋₄₀-arylalkenyl, C₁₋₈-oxyalkyl, C₂₋₆-oxyalkenyl, C₁₋₈-aminoalkyl, C₂₋₆-aminoalkenyl, C₁₋₈-alkyl ether, C₂₋₆-alkenyl ether, and —CY₂—R18, in which each Y is independently selected from H, CH₃, C₂H₅, C₃H₇; and
each R18 is independently selected from an optionally substituted heteroaryl selected from the group consisting of: pyridinyl; pyrimidinyl; pyrazinyl; triazolyl; pyridazinyl; 1,3,5-triazinyl; quinolinyl; isoquinolinyl; quinoxalinyl; imidazolyl; pyrazolyl; benzimidazolyl; thiazolyl; oxazolidinyl; pyrrolyl; carbazolyl; indolyl; and isoindolyl, wherein the heteroaryl is connected to —CY₂ via any atom in the ring of the selected heteroaryl; each Y is independently selected from H, CH₃, C₂H₅, and C₃H₇; and at least two of R17 are —CY₂—R18.

8. The process of claim 2 wherein the bispidon ligand is iron(1+), chloro[dimethyl 9,9-dihydroxy-3-methyl-2,4-di(2-pyridinyl-kN)-7-[(2-pyridinyl-kN)methyl]-3,7-diazabicyclo[3.3.1]nonane-1,4-dicarboxylate-kN3,kN7]-, chloride(1:1)

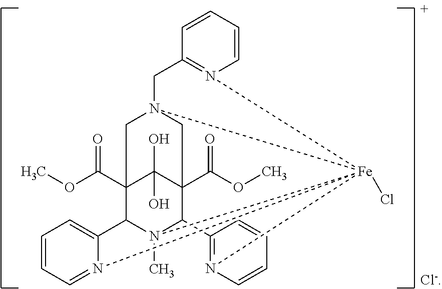

9. The process of claim 1 wherein
the at least one ligand is 1,4,7-trimethyl-1,4,7-triazacyclononane; and
the at least two Lewis Acids are Lewis Acid metal halides comprising aluminum halide and potassium halide; and
a ratio of 1,4,7-trimethyl-1,4,7-triazacyclononane to Lewis Acid metal halide ranges from 0.001 to 1,000/1 inclusive.

10. The process of claim 1 wherein
the at least two Lewis Acids are a metal halide, a metal carboxylate or mixtures or blends thereof; or
the at least two Lewis Acids comprise an aluminum halide, a potassium halide or a copper carboxylate.

11. The process of claim 10 with the provisos that:
the at least two Lewis Acids comprise metal halides; and
the metal of the Lewis Acids metal halides is selected from the group consisting of aluminum and potassium.

12. The process of claim 1 which further comprises:
the step of adding at least one metal ligand complex and at least one of the at least two Lewis acids to an alkyd-based paint formulation, an alkyd-based ink formulation or a composite or gel coating formulation based on unsaturated polyester resin, styrene or acrylate monomers, or vinyl ester resin; or
at least one step selected from the group consisting of: a step of adding at least one antiskinning compound; a step of adding one or more auxiliary driers or secondary driers; a step of adding at least one UV stabilizer; a step of adding at least one dispersant; a step of adding at least one surfactant; a step of adding at least one corrosion-inhibitor; a step of adding at least one filler; a step of adding at least one antistatic agent; a step of adding at least one flame-retardant; a step of adding at least one lubricant; a step of adding at least one antifoaming agent; a step of adding at least one antifouling agent; a step of adding at least one bactericides; a step of adding at least one fungicide; a step of adding at least one algaecide; a step of adding at least one insecticide; a step of adding at least one extender; a step of adding at least one plasticizer; a step of adding at least one antifreezing agent; a step of adding at least one wax; a step of adding at least one thickener; and a step of adding at least one pigment.

13. The process of claim 1 which further comprises:
the step of pre-combining the at least one metal ligand complex with at least one of the at least two Lewis Acids prior to addition to the aqueous alkyd resin coating; or
the step of adding the at least two Lewis Acids occurs before the step of adding the metal ligand complex.

14. A coating composition which comprises:
at least one metal wherein the metal is selected from the group consisting of Fe, V, Cu and Mn; and
at least one ligand selected from the group consisting of Bispidon, N4py type, TACN-type, Cyclam and cross-bridged ligands, and Trispicen-type ligands, said ligands added as an in-situ complex or as a pre-made complex with the at least one metal; and
at least two Lewis Acid halides.

15. (canceled)

16. The coating composition of claim 14, wherein the at least two Lewis Acid halides comprise an aluminum halide and a potassium halide.

17. The coating composition of claim 14, wherein the at least one ligand is a Bispidon ligand.

18. The coating composition of claim 14, wherein the at least one ligand is a TACN-type ligand.

19. The coating composition of claim 14, further comprising at least one of one or more auxiliary driers or secondary driers, one or more UV stabilizers, one or more dispersants, one or more surfactants, one or more corrosion-inhibitors, one or more fillers, one or more pigments, one or more antistatic agents, one or more flame-retardants, one or more lubricants, one or more antifoaming agents, one or more antifouling agents, one or more biocides, one or more plasticizers, one or more antifreezing agents, one or more waxes, and one or more thickeners.

20. The coating composition of claim 14, further comprising an alkyd resin suitable for an alkyd-based paint formulation.

21. The coating composition of claim 20, wherein the at least two Lewis Acids comprise up to 1% metal on alkyd resin solids.
